(19) United States
(12) Patent Application Publication
(10) Pub. No.: US 2014/0023690 A1
(43) Pub. Date: Jan. 23, 2014

(54) POLYMER SURFACES CONTAINING HEAT LABILE COMPONENTS ADSORBED ON POLYMERIC CARRIERS AND METHODS FOR THEIR PREPARATION

(71) Applicants: Frank M. Fosco, JR., Plainfield, IL (US); Edward E. Sowers, Plainfield, IN (US)

(72) Inventors: Frank M. Fosco, JR., Plainfield, IL (US); Edward E. Sowers, Plainfield, IN (US)

(21) Appl. No.: 13/724,500

(22) Filed: Dec. 21, 2012

Related U.S. Application Data
(63) Continuation-in-part of application No. 13/550,165, filed on Jul. 16, 2012.
(60) Provisional application No. 61/508,354, filed on Jul. 15, 2011.
(60) Provisional application No. 61/537,270, filed on Sep. 21, 2011.
(60) Provisional application No. 61/537,272, filed on Sep. 21, 2011.
(60) Provisional application No. 61/579,237, filed on Dec. 22, 2011.
(60) Provisional application No. 61/580,429, filed on Dec. 27, 2011.
(60) Provisional application No. 61/580,431, filed on Dec. 27, 2011.
(60) Provisional application No. 61/580,440, filed on Dec. 27, 2011.
(60) Provisional application No. 61/580,767, filed on Dec. 28, 2011.
(60) Provisional application No. 61/580,842, filed on Dec. 28, 2011.
(60) Provisional application No. 61/580,858, filed on Dec. 28, 2011.
(60) Provisional application No. 61/581,225, filed on Dec. 29, 2011.

(51) Int. Cl. A01N 25/10; A01N 55/00

(52) U.S. Cl. CPC A01N 25/10; A01N 55/00
USPC 424/404; 424/409; 424/402; 514/63

(57) ABSTRACT

Surfaces and members having one or more surfaces derived from compositions containing polymers and one or more heat labile and/or incompatible components adsorbed on carrier materials are provided. The heat labile components include materials that, unless adsorbed on a carrier, are transformed at the polymer's processing temperatures (such as for example, heat labile biocides). Incompatible components are materials that generally react or form gels, slimes or precipitates upon mixing. The carrier materials typically include inorganic and/or organic porous materials capable of remaining solid during processing temperatures. Methods for preparing the polymer surfaces and members having polymer surfaces are provided. Members include, but are not limited to, structures, articles, containers, devices, woven/nonwoven articles, remediation materials, and the like.

### CROSS-REFERENCE TO RELATED APPLICATIONS

This application is a continuation-in-part of U.S. patent application Ser. No. 13/550,165 filed on Jul. 16, 2012, which claims the benefit of U.S. Provisional Patent Application No. 61/508,354, filed Jul. 15, 2011, U.S. Provisional Application No. 61/537,270, filed Sep. 21, 2011, and U.S. Provisional Application No. 61/537,272, filed Sep. 21, 2011, and this application also claims the benefit of U.S. Provisional Application No. 61/579,237 filed on Dec. 22, 2011, U.S. Provisional Application No. 61/580,429, filed Dec. 27, 2011, U.S. Provisional Application No. 61/580,431, filed Dec. 27, 2011, U.S. Provisional Application No. 61/580,440, filed Dec. 27, 2011, U.S. Provisional Application No. 61/580,767, filed Dec. 28, 2011, U.S. Provisional Application No. 61/580,842, filed Dec. 28, 2011, U.S. Provisional Application No. 61/580,858, filed Dec. 28, 2011, and U.S. Provisional Application No. 61/581,225, filed Dec. 29, 2011, all of which are hereby incorporated by reference in their entirety.

### BACKGROUND

The present invention relates surfaces and members having at least one such surface, where the surface is derived from a polymer composition that includes a heat labile component/carrier combination and where the composition has been processed at a temperature above the heat labile component's transformation temperature. The heat labile component's transformation temperature is a temperature at which the component is normally transformed by inactivation, volatilization, decomposition, chemical reaction, and combinations thereof. The compositions provided are prepared by a method which avoids transformation of the heat labile component when composition containing the component is processed at elevated temperatures above the component's transformation temperature. Members are typically machines or manufactures and can include, but are not limited to, structures, articles, containers, devices, woven/nonwoven articles, remediation materials, and the like as well as their components. The terms utilized to describe are in some cases overlapping allowing a member be described by two or more terms. For example a container might also be considered an article.

The inclusion of a heat labile component such as, for example, a biocide into a polymer composition utilized to form a surface included in a member can provide important properties to the resulting surface and/or member, provided transformation (particularly, decomposition) can be avoided. For example members having surfaces derived from polymer/biocide compositions can be more resistant to biological degradation and provide surfaces that don't support the growth of a range of organisms and/or viruses and which can kill identified organisms (including bacteria, fungi, algae, viruses, and the like) which contact the surface. Such polymer/biocide compositions find particular uses in medical and related fields in which a need exists to create surfaces and members such as equipment, and polymeric fabrics capable of: resisting the survival and colonization of microorganisms, killing microorganisms upon contact, and/or providing a barrier to microorganisms. Unlike topical applications of biocides which typically provide a concentration gradient across the applied surface leading to resistant strains, a polymer having a uniform distribution of a biocide, provides a surface lacking such a concentration gradient and at proper levels minimizes the formation of resistant strains. In addition, the biocidal properties provided by the polymer/biocide composition are not dependent on whether a surface disinfectant was or was not applied according to established procedures. Further, the bulk of the polymer composition provides an ongoing reservoir of biocide for continued effect. The ability to provide and maintain such substantially sterile surfaces and minimize the formation of resistant strains of microorganisms is particularly important in today's hospital environment and in related fields.

Most polymers used to prepare surfaces associated with structures, articles, containers, devices, fabrics (both woven and nonwoven) and remediation materials pass through a molten state at relatively high temperatures during processing. Depending on the polymer, such processing temperatures typically range from about 180° C. to about 550° C. For a heat labile component such as a biocide to be successfully incorporated into such a polymer composition utilizing these standard methods, it must typically have sufficient thermal stability to survive any necessary processing at the elevated temperatures. Currently only a limited number of inorganic biocides have been successfully incorporated to provide polymers that exhibit some level of biocidal activity utilizing common manufacturing practices. Decomposition while processing a melt phase of the polymer biocide combination has typically inactivated organic biocides included in the combination.

Substantially sterile surfaces can be particularly important for each of the members having surfaces including, but not limited to, structures, articles, containers, devices, woven/nonwoven articles, remediation materials, and the like. Such structures are particularly important in work and living areas, and in the area of mass transportation, in theaters, in restaurants, and in arenas. Structures can vary in size as illustrated by a football stadium, a commercial aircraft, a home, and a birdhouse or a beehive.

Substantially sterile article surfaces can be important for articles or their components used in food preparation such as cutting boards, bins, counter tops and the like; knives and surgical equipment; a ball; a pencil; a filter; a handle; a paper clip; and the like. Some articles can pass microorganisms to others in a serial manner because of the way they are typically used or handled. Other articles are able to transfer microorganisms by contaminating elements of our food supply. Articles can vary in size as illustrated by a paperclip and beach ball. Like structures and articles containers benefit from the ability to maintain their surfaces substantially sterile. This is particularly important for containers used with regard to materials consumed and contacted, such as for example, for containing potable water and other liquids, drinks, other fluids, foods, medicines, cosmetics, and the like. Containers can vary in size as illustrated by a lined soft drink can and a lined tank for city water.

Devices similarly benefit from surfaces that can maintain substantially sterile surfaces.

This is particularly important in devices used with regard to materials consumed and involved with serial contact by multiple individuals. Examples include, for example, devices used for measuring, combining, mixing, or otherwise contacting components utilized in the preparation of liquids, drinks, other fluids, foods, medicines, cosmetics, and the like. Devices can vary in size as illustrated by a gallon sized home ice cream freezer to an industrial size ice cream freezer.

Woven and nonwoven materials also benefit by having surfaces that can prevent the growth and spread of micororganisms. Scrubs, surgical gowns, drapes, and the like in hospitals, doctors offices, capable of killing antibiotic resistant bacteria, viruses, fungi, and the like can minimize the spread of a variety of infections from an initial source. Bandages made from treated materials and covering an open wound can help prevent infection. Bedding and bedclothes made from a treated material can help prevent the infections that become bedsores. Socks containing a fungicide can prevent the development of athlete's foot. Appropriately treated upholstery material utilized in an airliner, a train, or a bus, can prevent the seat's surface from being a source of disease. Appropriately treated clothing worn by farmers who raise a variety of animals can prevent bacteria and viruses from the animal sources being introduced into the home when the farmer returns there from caring for his animals. Properly treated gloves can prevent a sick worker from transmitting a disease through items that he or she touch. Finally, clothing treated with an animal repellent can provide a region about the wearer free of insects, without the need of applying the repellent directly to the individual's skin.

Finally, such surfaces are also important in a variety of polymeric remediation materials utilizing the carrier technology which has until now been unavailable. For example, geotextile materials can be provided that repel or kill damaging burrowing animals (such as rodents) and thus minimize damage caused thereby. Insecticides and fungicides can be incorporated into biodegradable seed coatings to reduce attack by insects and microorganisms. Because the components introduced into the remediation materials are tightly held within the polymer, contamination of the surrounding environment is avoided or delayed as in the case of a biodegradable polymer.

What is needed is a range of surfaces associated with members such as structures, articles, containers, devices, fabrics (both woven and nonwoven) and remediation materials derived from polymer/heat labile component compositions which can be engineered in a variety of forms utilizing substantially standard manufacturing techniques and which can include one or more heat labile components, such as for example, biocides selected to fulfill a specific need, without regard to whether or not the biocide is provided sufficient thermal stability to survive the necessary polymer processing. Further, methods are needed for producing surfaces derived from such polymer/heat labile component compositions, wherein the heat labile component's necessary properties are maintained following one or several thermal processing steps. The current disclosure addresses these needs.

### SUMMARY

In its broadest form, the present disclosure provides for surfaces prepared from modified solid materials formed from a molten or liquid state and containing a heat labile component initially adsorbed in a carrier particle that alone and unassociated with the carrier particle would not be capable of surviving the conditions of the molten or liquid state. Although not required, the molten or liquid states typically occur at elevated temperatures, that is temperatures above ambient temperatures. Failure of the component alone to survive can result from inactivation, decomposition, volatilization, chemical reaction and the like. The surfaces described herein can be incorporated into members which include, but are not limited to structures (and structural components), articles, containers, devices, woven/nonwoven articles, remediation materials, and the like.

One aspect of the present disclosure provides for surfaces derived from a polymer including a heat labile component adsorbed on a carrier and members incorporating these surfaces. The polymer has a melting temperature and the heat labile component has a decomposition temperature, wherein the polymer's melting temperature is greater than the heat labile component's decomposition temperature. The surface of the polymeric member can be formed from a molten mixture of the polymer and heat labile component adsorbed on a carrier particle under conditions which would result in decomposition or volatilization of the heat labile component without involvement of the carrier particle. The molten states generally occur at elevated temperatures, typically greater than or equal to about 180° C. The addition of a heat labile component to a molten polymer without a carrier typically results in the components inactivation, decomposition, volatilization and the like, depending on the manner in which the component is heat labile. The component/carrier combination further protects a heat labile component from elevated temperatures during the article's service. Finally, articles derived from polymers including a plurality of component/carrier combinations can be constructed from polymers having at least one component that is incompatible with another component, or the polymer itself when the incompatible component is not adsorbed on a carrier. Materials are incompatible with each other or a formulation if their combination caused a result that interferes with the purpose of their combination. Examples of such interference include, but are not limited to a chemical reaction, the formation of a precipitate or slime and related interactions.

The word “structure” is meant to describe an item having components arranged in a particular order for a particular purpose. Structures can have a skeletal arrangement or a frame to provide strength and shape, as in a house, or be constructed of walls that are joined that provide sufficient support and provide a shape. A larger structure such as a house typically has a frame which is erected and enclosed within the walls, floor, attic and the like. The frame, the walls, the floor, the ceiling, the roof, and the like are structural components. For a house, examples of structural components include, but are not limited to, items such as doors, windows, a chimney, shingles, vents, gutters, a foundation, floors, walls, ceilings, and the like. For a structure used as transportation, such as an airliner, structural components include, but are not limited to, doors, windows, seats, cushions, luggage bins, landing gear, restroom facilities, luggage compartment, cabin walls, and the like.

A structure can also be constructed to provide novel surface properties by preparing a structure by any available method and with any available material, and applying a surface treatment to the structure's surface. Surface treatments can include paints, coatings, stains, varnishes, sealants, films, inks, and the like. For some applications, the use of component/carrier combinations protects the resulting structure surface during application of the coating (as in the case of powder coatings and other thermoset coatings), whereas in other applications, protection is afforded the structure after application, during the structure's service. In still other applications, component/carrier combinations are used to incorporate an incompatible component into the surface coating. Component/carrier combinations can be included in the surface treatment formulation during its preparation or, alternatively, just before its application, and the surface treatment can be applied to the structure by standard methods.

The word “article” is meant to describe one of an unspecified class of objects. An article can be formed directly by molding, or subsequently constructed from extruded polymer components, depending on the nature of the article and by other means. Construction can involve the use of hot melt adhesives containing component/carrier combinations corresponding to those included in the polymer to provide a complete article surface exhibiting the same or similar properties.

The word “container” is meant to describe something used for storing or holding things, whether the things are solids, liquids, or gasses. A container can be formed directly by molding, or subsequently constructed from extruded polymer components, depending on the nature of the container. Construction can involve the use of hot melt adhesives containing component/carrier combinations corresponding to those included in the polymer to provide a container surface exhibiting the same or similar properties.

The word “device” is meant to describe a machine or piece of equipment that does a particular thing by the operation of a mechanism (mechanical and/or electrical). A device or its components can be formed directly by molding, or subsequently constructed from extruded polymer components, depending on the nature of the device. Optionally, individual elements of a device may be formed directly by molding, or subsequently constructed from extruded polymer components, depending on the nature of the element and then the device assembled from such elements. Alternatively, a device may be assembled using a combination of polymer components and non-polymer components. Construction can involve the use of hot melt adhesives containing component/carrier combinations corresponding to those included in the polymer to provide a device surface exhibiting the same or similar properties.

The terms “woven or nonwoven fabric” is meant to describe a cloth and fabric types of materials made by crossing threads over and under each other (weaving) and by a process that does not involve weaving, respectively. The formation of a woven fabric requires the initial formation of a thread or filament that is ultimately woven to form the fabric. Nonwoven fabrics are typically formed by extrusion.

The term “remediation material” is meant to describe an article intended to improve a situation or correct a problem. Frequently such materials are used to improve or correct a problem in the environment. Remediation materials can have forms ranging from fabrics, panels, granules, and the like. The inclusion of one or more components into the remediation material allows the remediation material to exhibit properties derived from the incorporated component. A remediation material can be formed directly by molding, extruding, pelletizing, fusing, weaving, or it can be subsequently constructed from extruded polymer components by lamination, coating, and the like, depending on the nature of the remediation material.

A further aspect of the present disclosure also provides a method for preparing surfaces and members having surfaces from the carrier loaded component and for incorporating the component/carrier combination into the molten material, mixing the combination, and solidifying the molten mixture to provide a substantially homogeneous solid containing the component, substantially unchanged. Polymers have proven particularly useful as solid materials capable of forming molten forms for this application.

A still further aspect of the present disclosure provides for the incorporation of the surfaces into members including structures, articles, containers, devices, woven/nonwoven articles, remediation materials, and the like. The properties of the members having surfaces derived from a modified polymer are similarly modified.

A narrower perspective of the present disclosure provides for a surface derived from a polymer/biocide composition (a “biocidal polymer”) exhibiting antimicrobial properties wherein the composition was formed and/or processed at temperatures above the biocide's transformation or decomposition temperature, without substantial decomposition of the biocide. Further, methods are provided for preparing the polymer/biocide compositions. The surfaces can be incorporated into members including structures, articles, containers, devices, woven/nonwoven articles, remediation materials, and the like.

In the discussions which follow, the focus will be on biocides as examples of heat labile components. However, it is understood that except for the nature of the properties exhibited, the concepts described for heat labile biocides relate to other heat labile components and/or incompatible components capable of expressing a desirable property in a resulting modified polymer surface.

A first aspect of the present disclosure includes a surface derived from a polymer having a continuous solid phase and a heat labile component/carrier combination. The polymer has a melting temperature, the heat labile component has a transformation temperature, the polymer's melting temperature is greater than the heat labile component's transformation temperature, and the heat labile component/carrier combination is distributed throughout the polymer's continuous phase. One example includes a surface derived from a biocidal polymer having a melting temperature and a heat labile biocide adsorbed on a carrier and having a transformation or decomposition temperature where the polymers melting temperature is greater than the biocide's transformation or decomposition temperature. The carrier is typically a porous material which remains solid at the processing temperature upon which a sufficient amount of heat labile biocide can be adsorbed. In the polymer/biocide composition, the biocide is typically distributed throughout the polymer including its surface, but is not limited to placement on its surface.

Although some polymers can have melting temperatures as low as 100° C., preferred polymers typically have a melting temperature or a glass transition temperature (ranging from about 180° C. to about 550° C.) above which the polymer forms a viscous liquid to which a biocide/carrier combination can be added and mixed during processing. Such mixing provides for a generally uniform distribution of the various components within the mix and any subsequent article derived from the mix. Such polymers can include, but are not limited to organic polymers, inorganic polymers, copolymers including mixed organic/inorganic polymers, linear polymers, branched polymers, star polymers, and mixtures thereof. Depending on the biocide concentration, cooling and solidification of the resulting polymer/biocide composition can provide a product ranging from a concentrate (a “masterbatch”) for subsequent incorporation into additional polymer to a finished article. Such masterbatch materials can be based on a single polymer or on a polymer blend.

Suitable masterbatch combinations of a carrier/heat labile component and a second material can be a solid or a liquid. Such masterbatch combinations allow incorporation of the carrier/heat labile component into polymers during current manufacturing processes along with other solids, liquids, and/or combinations thereof. One such masterbatch embodiment involves a carrier/heat labile component incorporated into a polymer or polymer blend to provide a solid form, such as for example, a pellet or a powder form. Masterbatch materials can similarly involve a suspension or dispersion of the carrier/heat labile material in a liquid suitable for incorporation into a finished polymer material or article during manufacture. The liquid masterbatch formulation provides material handling advantages such as improved metering capabilities. Suitable liquid phase materials for the carrier dispersions or suspensions include, but are not limited to mineral oil, soybean oil, castor oil, linseed oil, alkyl phthalates, citric acid esters, and the like. Additional polymer additives can be included in the liquid masterbatch formulation such as colorants, plasticizers, UV stabilizers, and the like. As illustrated in the Examples, the carrier/heat labile component loading in such masterbatch materials is typically higher than intended in a finished product to account for dilution when combined with a bulk polymer.

Preferred biocides include, but are not limited to bacteriocides, fungicides, algicides, miticides, viruscides, insecticides, herbicides rodenticides, animal and insect repellants, and the like, which suffer some level of decomposition, inactivation, and/or volatilization at the temperatures required to incorporate the biocide into the polymer/biocide composition, and/or which offer some advantage to the resulting polymer/biocide combination. In other words, the heat labile biocide is inactivated, decomposes or vaporizes upon exposure to the elevated temperatures and/or processing conditions if not adsorbed on a carrier. For biocide mixtures, at least one of the biocide components is typically heat labile. One kind of suitable biocide includes biocides containing a quaternary amine group that accounts for some level of the compound's biocidal activity.

Suitable heat carriers are generally insoluble in the polymer's liquid phase, do not melt, or otherwise cease the function of a carrier during processing, and have a relatively high internal surface area. Carriers can be porous and have an internal surface area to allow the adsorption of necessary levels of the biocide or non-porous, having been loaded during a low temperature polymerization of a monomer mixture containing a heat labile component. The biocide can be adsorbed on the carrier by contacting the carrier with a liquid form of the biocide. If the biocide is a liquid at a temperature below its transition or decomposition temperature it can be used directly in its liquid form. If the biocide is a solid at the necessary processing temperatures, it can be dispersed or dissolved in a solvent, prior to adsorption onto the carrier. Any remaining excess solvent or dispersant can be removed or evaporated to provide a flowable carrier containing the biocide, for subsequent incorporation into a polymer. Solvents such as the lower boiling alcohols, for example, can be left on the carrier/biocide combination and the excess solvent volatilized upon contact with the molten polymer. For a carrier to be loaded with a dispersion of the biocide, the biocide's particle size should be smaller than the carrier's pores being entered. The term “transformation temperature” generally refers to a temperature at which a heat labile component is transformed by inactivation volatilization, decomposition, chemical reaction, and combinations thereof. The term “decomposition temperature” generally refers to the temperature at which a substance chemically decomposes to provide generally non-specific products.

A further aspect of the present disclosure involves a method for preparing the surfaces derived from the polymer/biocide composition described above. The method includes the steps of: providing a polymer and a heat labile component/carrier combination, subjecting the polymer to a processing temperature for a time sufficient to form a melt, distributing the heat labile component/carrier combination within the melt; and cooling the melt to form a continuous solid phase containing the heat labile component, with substantially no transformation of the heat labile component. The polymer has a melting temperature, the heat labile component has a transformation temperature, and the processing temperature is ≧ the polymer's melting temperature and the heat labile component's transformation temperature. No substantial transformation of the heat labile component has taken place if the polymer/biocide composition is not discolored and the composition exhibits characteristics derived from the heat labile component.

A further variation of the method where the heat labile component is a biocide involves, (a) providing a mixture including a polymer or polymer phase and a heat labile component such as a biocide adsorbed on a carrier, wherein the polymer or polymer phase has a melting temperature, the biocide has a transformation or decomposition temperature; (b) subjecting the mixture to a processing temperature for a processing time sufficient to form a substantially homogeneous melt containing the polymer or polymer phase and the biocide adsorbed on the carrier; and (c) cooling the melt to solidify the polymer/biocide/carrier composition and form a desired surface. Certain carriers are porous and have a generally low thermal conductivity. The method can further include a step of processing prior or subsequent to the cooling process to cause the polymer to have a desired form having a surface. A desired form can include, but is not limited to pellets, granular particles, an extruded bar, sheet or film, a laminate, a powder, a machined form, a filament, a woven article, a container, and the like. Some methods provide a surface that can be adapted into a member, whereas other methods can directly form a member from the polymer melt.

The time during which the polymer/biocide/carrier combination is subjected to a processing temperature should be sufficient to provide a generally uniform distribution of the biocide/carrier combination within the polymer melt; allow the resulting polymer/biocide/carrier combination to be conformed to and cooled in a desired form; but not so long that the biocide ultimately thermally decomposes. Preferred methods utilize a processing time of 30 minutes or less; more preferred methods utilize a processing time of 20 minutes or less, whereas the most preferred methods utilize a processing time of 15 minutes or less. Polymer/biocide combinations have been successfully prepared where the processing time ranged from as little as 1-2 minutes and as long as up to 30 minutes. Such processing times are applicable to the initial incorporation of the biocide/carrier combination into a polymer, whether a masterbatch or other desired form, and for any subsequent processing steps that require heating the polymer/biocide/carrier combination to temperatures at or above the biocide's decomposition temperature. Subjecting the polymer/biocide/carrier to extended periods of time above the biocide's decomposition temperature can ultimately result in biocide decomposition. How long the polymer/biocide/carrier combination can be maintained above the biocide's decomposition temperature depends primarily on the polymer selected, the carrier selected, the selected polymer's necessary processing temperature, and the biocide's rate of thermal decomposition or volatilization at the processing temperature of the selected polymer. Based on tests conducted thus far, additional cycles of heating and cooling can be carried out on the polymer/biocide combination for similar processing times without resulting loss of activity.

Finally, suitable heat labile components utilized to prepare a variety of surfaces can include materials having a range of biological activities (controlling the growth of microorganisms, plants, and insects), volatiles, such as fragrances, repellants, pheromones, water and aqueous solutions, and materials which react or are inactivated by the exposure to elevated temperatures. In addition, other materials incorporated into surfaces which are not heat labile will also likely benefit from the carrier technology provided. For example, the incorporation of materials such as plasticizers into carrier materials utilized in polymers may slow down the rate at which the plasticizer “blooms” to the plastic's surface, increasing its useful life. Additionally, mixtures of materials which are incompatible when mixed or otherwise combined can be loaded onto separate carriers and incorporated into a polymer utilized to prepare a surface to provide homogeneous compositions that could not otherwise be prepared. Incompatible components can include heat labile components and/or materials that would otherwise be stable at the processing temperatures.

A still further aspect of the current disclosure involves surfaces and members prepared from a composition that includes an encapsulated form of a heat labile component/carrier combination. Forms of the composition including higher levels of heat labile component/carrier combination are suitable for use as a masterbatch. Masterbatches can have a liquid or solid form suitable for incorporation into a polymer.

Additionally, the biocide or other heat labile component can be modified and/or extruded under conditions which result in it being concentrated closer to the extruded plastic's surface, thus further enhancing the extruded plastic's biocidal activity. In the discussions which follow, examples are provided in which single heat labile component/carrier combination as well as multiple heat labile component/carrier combinations is utilized. It is understood that for some applications a single heat labile component/carrier may be utilized, for other applications, multiple heat labile components may be loaded onto a single carrier, and for still other applications, multiple heat labile component/carrier combinations can be utilized. Reference to a single combination is intended to also cover these additional combinations whether the combinations are incorporated directly or after subjecting the combinations to encapsulation.

Each of the surfaces described herein can be incorporated into members including structures, articles, containers, devices, woven/nonwoven articles, remediation materials, and the like, and combinations thereof.

### DETAILED DESCRIPTION

For the purposes of promoting an understanding of what is claimed, references will now be made to the embodiments illustrated and specific language will be used to describe the same. It will nevertheless be understood that no limitation of scope of what is claimed is thereby intended, such alterations and further modifications and such further applications of the principles thereof as illustrated therein being contemplated as would normally occur to one skilled in the art to which the disclosure relates.

As used in the specification and the claims, the singular forms “a,” “an” and “the” include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not.

Providing surfaces for a variety of members from materials containing heat labile components in which the surface exhibits properties derived from one or more heat labile components utilizing standard methods has proven problematic. A majority of the components needed to impart the desired properties are heat labile and decompose or volatilize under conditions normally required to treat structural components or a fully formed structure. Further, during their use, structures, and/or their components can become exposed to elevated temperatures causing decomposition of any heat labile components incorporated therein. When a component within a structure's surface decomposes, any properties associated with that component are no longer expressed. In other instances, the structure experiences exposure to elevated temperatures during its service, that causes decomposition or volatilization. In addition, when a plurality of components (some of which can be heat labile components) is utilized to provide one or more properties, the necessary components often cannot be combined because one or more of the components are incompatible, that is they react, precipitate, or otherwise interfere with the formulations preparation. As a result, the formulation cannot exhibit the desired combination of properties. Surfaces formed from compositions containing a heat labile component having a transformation temperature that were processed at temperatures greater than the transformation temperature and which exhibit properties derived from the heat labile component are described herein. Members including these novel surfaces are similarly described. Finally, methods for forming these new surfaces and members including the new surfaces are also provided.

### Surfaces:

Surfaces containing the different heat labile components can be incorporated into a variety of members having a range of features, shapes, and uses. The surfaces can be external, internal, or a combination thereof. Surfaces can be formed in a number of ways including, but not limited to molding, extrusion, laminating, coating, and the like. The novel aspect of each surface includes its ability to be created utilizing standard manufacturing equipment from a molten polymer, and its ability to exhibit properties derived from or related to the heat labile component that could not be achieved without the utilization of the heat labile component/carrier combination. The presence of the heat labile component/carrier combination within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of surfaces contemplated include, but are not limited to contiguous surfaces, mesh surfaces, porous surfaces, nonporous surfaces, woven surfaces, and the like. Surfaces containing a heat labile component/carrier combination can remain sterile, kill microorganisms and the like upon contact, and prevent the spread of microorganisms though serial contact. Surfaces containing a repellent, such as an animal and/or insect repellent, can maintain a region about the surface free of animals, insects and the like. A surface containing an insecticide can kill insects sensitive to the insecticide utilized that contact the surface. A surface containing a combination pheromone/insecticide can attract pheromone sensitive insects and upon contacting the surface kill insects sensitive to the insecticide utilized.

The disclosed surfaces are particularly useful for controlling microorganisms which are spread by direct serial contact or a combination of serial contact and exposure to aerosols from sneezing and coughing and direct contact. Other surfaces are particularly useful for affecting fluids contacted such as the surface of a filter, container, and the like. Surfaces can be designed to exhibit a single property or a plurality of properties. Surfaces including one or more enzymes can effect chemical transformations upon contact, thus decomposing chemical compounds such as herbicides, fungicides, pesticides, lachrymatory agents, nerve gases, and the like.

### Members Having Modified Surfaces:

### Structures:

A structure and its structural components can be damaged, destroyed, and contaminated in a variety of ways. A variety of microorganisms, macroorganisms, and the like can infest and/or degrade a structure and become a source of pests, disease, and infection. Disease and infection can be passed on to those who come in contact with the structure or pass through it. The ability to protect a structure and its structural components from attack by insects can prevent structural damage and disease, whereas protecting the structure and its components from microorganisms can prevent the spread of disease and infection. In other cases, a structure's surface can be damaged by contact with light, moisture, temperature extremes and other environmental conditions.

Certain surface properties can facilitate and enable a stationary structure to maintain its structural integrity, free of insects, spiders, and the like; safely house humans and other organisms without the spread of disease and infection; and avoid mildew growth during periods of high moisture. The same surface properties can enable a mobile structure, such as a bus to provide transportation and discharge its passengers without contributing to the spread of disease and infection.

The following examples are illustrative, and not intended to be restrictive in any manner. For example, a structure, such as a house, having a frame coated with a polymeric surface treatment containing an insecticide and a mildewcide can prevent insect infestations and mildew formation from becoming established within the structures walls upon experiencing flooding or high moisture levels. A commercial airliner having internal walls coated with a polymer contain a bacteriocide, a viruscide, and/or a mildewcide; seats with upholstery including similar agents; and air treated by passage through a filter including similar agents, can transport one or more individuals suffering from a communicable disease without transmitting it to other passengers. A birdhouse constructed from a polymer containing a bacteriocide, a viruscide, and/or a mildewcide can prevent the passage of bird flu to other birds that come in contact with the birdhouse. A bee hive having internal surfaces that include a miticide can protect the bees therein from the Varroa mites, responsible for destroying many bee colonies. Finally, a structure having an exterior surface and/or a frame coated with a rodenticide can prevent rodents from successfully gnawing an entryway into the structure and control their population. The incorporation of animal and/or insect repellents into structural components can create a region about a structure where animal and/or insect populations are reduced or eliminated. The incorporation of a herbicide into appropriate structural components can prevent the growth of unwanted vegetation in the immediate vicinity of the structure. A structure for grain storage having structural components including one or more rodenticides can eliminate rodents that attempt to gain entry into the structure by gnawing through a component containing a rodenticide. Providing structures with these properties utilizing standard methods has proven problematic. A majority of the components needed to impart the desired properties are heat labile and decompose or volatilize under conditions normally required to treat structural components or a fully formed structure. Further, during their use, structures, and/or their components can become exposed to elevated temperatures causing decomposition of any heat labile components incorporated therein. When a component within a structure's surface decomposes, any properties associated with that component are no longer expressed. In other instances, the structure experiences exposure to elevated temperatures during its service, that causes decomposition or volatilization. In addition, when a plurality of components (some of which can be heat labile components) is utilized to provide one or more properties, the necessary components often cannot be combined because one or more of the components are incompatible, that is they react, precipitate, or otherwise interfere with the formulations preparation. As a result, the formulation cannot exhibit the desired combination of properties.

Certain structures can be constructed entirely from polymers or in part from polymers by utilizing a polymer laminate, a film, or a coating derived from a surface treatment. For example, the interior of a mobile structure used for transportation can include an internal lining or upholstery derived from polymeric materials extruded at an elevated temperature. Other structures, such as a building utilized for living or working, can include a variety of structural components which are constructed, all or in part, from polymeric materials, or which have a surface coating derived from a polymeric surface treatment. In order to provide the necessary properties to the polymers, polymer components, and surface coatings, additional components are needed, most of which are heat labile, and unable to survive varying periods of time at elevated temperatures during processing, or subsequently during the completed structure's service. Other desired components are incompatible with other components of the formulation and interfere with the formulation's preparation and/or application.

For example, extrusion, injection molding, the curing of a thermoset resin, and other methods for processing polymers require the formation of a melt at elevated temperatures substantially above a heat labile component's decomposition or volatilization temperature. Additionally, the ability to form a structure having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous coatings, oil base coatings, or powder coatings and can be applied and cured, when necessary, according to procedures known in the art. Powder coatings are particularly useful for coating large structures, particularly large metal structures. Component/carrier combinations can be included during the preparation of the surface treatment or included in the formulation just prior to its application.

A variety of heat labile components and/or incompatible components can be incorporated into the surface of a variety of structures having a range of features, shapes, and uses. The surfaces can be external, internal, or a combination thereof. The structure's surfaces can be formed in a number of ways known in the art and described herein. Structure or structure surfaces can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of structure surfaces contemplated include, but are not limited to solid surfaces, mesh surfaces, porous surfaces, and the like. structure surfaces containing a heat labile component/carrier combination can remain sterile, kill microorganisms and the like upon contact, and prevent the spread of microorganisms though serial contact. Structure surfaces containing a repellent, such as an animal and/or insect repellent, can maintain a region about the surface free of animals, insects and the like. A structure's surface containing an insecticide can kill insects sensitive to the insecticide utilized that contact the surface. A structure's surface containing a combination pheromone/insecticide can attract pheromone sensitive insects and upon contacting the surface kill insects sensitive to the insecticide utilized.

### Articles:

An article can transfer microorganisms as a result of being handled by a variety of individuals in a serial manner, by being used in connection with surgery or medical treatment where a cut or tear in the skin provides an entry for a microorganism, and because of the article's utilization in the production, handling, processing, packaging, preparation, and/or consumption of foods and drinks.

The ability to protect an article's surface from microorganisms would substantially reduce a population's contact and exposure to microorganisms currently encountered, thus reducing human and animal exposure to a variety of diseases and infections. In order to enable an article's surface to avoid the spread of microorganisms which they are exposed to, an article's surface should express a variety of properties. The following examples are illustrative, and not intended to be restrictive in any manner. For example, pencils having an external surface that kills and/or prevents the reproduction of bacteria, fungi, algae, viruses, and the like used in a school room by one or more sick children can prevent the pencil from becoming a vehicle for the transmission of a variety of diseases. Similarly, articles having a similar surface and utilized in a hospital where microorganisms abound, can be a barrier to their further proliferation and transmission. Articles having a surface containing an insect repellent can be strategically placed on a patio or deck to maintain an insect free area within the article's proximity. Articles having a surface containing both an insecticide and an insect pheromone can be utilized to reduce an insect's population. A mailbox post having a surface containing a herbicide can prevent grass and weeds from growing at the post's edge, reducing landscape efforts. Articles containing a food product and a rodenticide can be placed within a rodent population in order to diminish the rodent population. Additionally, articles such as wiring insulation, feed packaging, and the like which may be exposed to rodents and/or insects may include a rodenticide and/or an insecticide to prevent vermin from chewing on the articles.

Articles can be constructed entirely from polymers or in part from polymers by utilizing a polymer laminate, a film, or a coating derived from a surface treatment. For example, a plastic handle for a utensil or a tool, can be molded from a polymer melt. A counter top can include an extruded layer from a polymer melt and used to prepare a laminate. Other articles can be formed by a variety of means and coated with a thermoset resin. Extrusion, injection molding, the curing of a thermoset resin, and other methods for processing polymers require the formation of a melt at elevated temperatures substantially above a heat labile component's decomposition or volatilization temperature. Additionally, the ability to form an article having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous coatings, oil base coatings, or powder coatings and can be applied and cured, when necessary, according to procedures known in the art. Powder coatings are particularly useful for coating large articles, particularly large metal articles. Component/carrier combinations can be included during the preparation of the surface treatment or included in the formulation just prior to its application.

A variety of heat labile components and/or incompatible components can be incorporated into the surface of a variety of articles having a range of features, shapes, and uses. The surfaces can be external, internal, or a combination thereof. The article's surfaces can be formed in a number of ways known in the art and described herein. Each article or article surface can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of article surfaces contemplated include, but are not limited to solid surfaces, mesh surfaces, porous surfaces, and the like. Article surfaces containing a heat labile component/carrier combination can remain sterile, kill microorganisms and the like upon contact, and prevent the spread of microorganisms though serial contact. Article surfaces containing a repellent, such as an animal and/or insect repellent, can maintain a region about the surface free of animals, insects and the like. An article's surface containing an insecticide can kill insects sensitive to the insecticide utilized that contact the surface. An article's surface containing a combination pheromone/insecticide can attract pheromone sensitive insects and upon contacting the surface kill insects sensitive to the insecticide utilized.

### Containers:

A container's contents can be damaged, destroyed, consumed, and contaminated in a variety of ways. A variety of microorganisms, macroorganisms, and the like can consume and/or degrade a container's contents and additionally enable secondary effects, such as disease, unsanitary conditions, and the like, to be passed on to those who consume or otherwise handle and come in contact with the contents. The ability to protect a container's contents from attack by micro- and macroorganisms would avoid the content's loss and destruction and additionally prevent the contents from becoming a vehicle for the transmission of diseases, illnesses, and the like. In other cases, a container's contents can be damaged or destroyed by contact with light, temperature extremes, and other environmental conditions.

In order to enable a container's surface to receive, maintain, culture, and discharge its contents in a condition that protects the content's quantity and quality as well as those who consume or otherwise handle them, a container's surface should express a variety of properties. The following examples are illustrative, and not intended to be restrictive in any manner. For example, a tank or pipe utilized to store or transport a fluid such as water or milk, for example, having an internal surface that kills and/or prevents the reproduction of bacteria, fungi, algae, viruses, and the like can maintain and even reduce the microorganism content of the fluid contained and/or transported therein. The inclusion of an appropriate enzyme can provide for the destruction of a variety of pesticides, nerve gas components and the like similarly contained in the fluid. A garbage can having a surface that includes animal and/or insect repellents can hold garbage for disposal without attracting animals and/or insects. The replacement of the animal repellent with an insecticide can cause the surface to exhibit insecticidal properties, rather than insect repellent properties. The internal surface of a tank utilized for the hydroponic growth of vegetables, can include one or more selective herbicides and algaecides to prevent unwanted vegetation that interferes with vegetable production. A container that includes both an insect pheromone and an insecticide can become a trap for the selective destruction of specific insects. A container for grain having a surface containing a rodenticide can destroy any rodents that attempt to gnaw into the container in search of food. A bee hive having internal surfaces that include a miticide can protect the bees therein from the Varroa mites, responsible for destroying many bee colonies. A clear plastic bottle having a surface containing a component that absorbs ultraviolet light can protect contents sensitive to the ultraviolet light.

Containers can be constructed entirely from polymers or in part from polymers by utilizing a polymer laminate, a film, or a coating derived from a surface treatment. For example, containers for bottled water can be prepared from polyesters; soft drink cans can be prepared from aluminum and lined with a polymer film or laminate (interior and/or exterior); tanks can be constructed from extruded sheets of polymer or coated with a thermoset resin. Extrusion, injection molding, the curing of a thermoset resin, and other methods for processing polymers require the formation of a melt at elevated temperatures substantially above a heat labile component's decomposition or volatilization temperature. Additionally, the ability to form a container having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous coatings, oil base coatings, or powder coatings and can be applied and cured, when necessary, according to procedures known in the art. Powder coatings are particularly useful for coating large containers, particularly large metal containers. Component/carrier combinations can be included during the preparation of the surface treatment or included in the formulation just prior to its application.

A variety of heat labile components and/or incompatible components can be incorporated into the surface of a variety of containers having a range of features, shapes, and uses. The surfaces can be external, internal, or a combination thereof. The container's surfaces can be formed in a number of ways known in the art and described herein. Each container or container surface can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of container surfaces contemplated include, but are not limited to solid surfaces, mesh surfaces, porous surfaces, and the like. Container surfaces containing a heat labile component/carrier combination can remain sterile, kill microorganisms and the like upon contact, and prevent the spread of microorganisms though serial contact. Container surfaces containing a repellent, such as an animal and/or insect repellent, can maintain a region about the surface free of animals, insects and the like. A container's surface containing an insecticide can kill insects sensitive to the insecticide utilized that contact the surface. A container's surface containing a combination pheromone/insecticide can attract pheromone sensitive insects and upon contacting the surface kill insects sensitive to the insecticide utilized.

### Devices:

When in use, a device may contact or otherwise interact with objects and/or substances which can be damaged, destroyed, consumed, and contaminated in a variety of ways. A variety of microorganisms, macroorganisms, and the like can consume, infect, spoil, contaminate, and/or degrade objects and/or substances a device contacts and additionally enable secondary effects, such as disease, conditions, and the like, to be passed on to those who consume or otherwise handle and come in contact with the contents. The ability to protect objects and/or substances a device contacts from attack by micro- and macroorganisms would avoid the objects/substances loss and destruction and additionally prevent the objects/substances from becoming a vehicle for the transmission of diseases, illnesses, and the like. In other cases, objects and/or substances a device contacts can be damaged or destroyed by contact with light, temperature extremes and other environmental conditions.

In order to enable a device's surface(s) to receive, maintain, culture, discharge, or otherwise perform its function in a manner that protects the objects and/or substances a device contacts as well as protecting those who consume or otherwise handle them, a device's surface(s) and/or components should express a variety of properties. The following examples are illustrative, and not intended to be restrictive in any manner. For example, a pump/pipe system utilized to transfer a fluid such as water or milk, for example, having an internal surface that kills and/or prevents the reproduction of bacteria, fungi, algae, viruses, and the like can maintain and even reduce the microorganism content of the fluid contained and/or transported therein. The inclusion of an appropriate enzyme can provide for the destruction of a variety of pesticides, nerve gas components and the like similarly contained in the fluid. A camping stove's non-cooking surface having a finish that includes animal and/or insect repellents can be used for cooking without residual food odors attracting animals and/or insects. The replacement of the animal repellent with an insecticide can cause the surface to exhibit insecticidal properties, rather than insect repellent properties. The internal surface of a fluid distribution system utilized for the hydroponic growth of vegetables can include one or more selective herbicides to prevent unwanted vegetation that interferes with vegetable production. A device that includes both an insect pheromone and an insecticide can become a trap for the selective destruction of specific insects. A device for handling/transporting grain having a surface containing a rodenticide can destroy any rodents that attempt to gnaw into the device in search of food. A bee hive having internal surfaces that include a miticide can protect the bees therein from the Varroa mites, responsible for destroying many bee colonies. Eye-glass lenses containing a component that absorbs ultraviolet light can protect the wearer's eyes sensitive to the ultraviolet light.

Devices can be constructed entirely from polymers or in part from polymers by utilizing a polymer laminate, a film, or a coating derived from a surface treatment. For example, pumps for transferring water can have components prepared from polyurethanes; appliance cases can be prepared from aluminum or other metal and coated or laminated with a polymer such as epoxy coating (interior and/or exterior); tanks can be constructed from extruded sheets of polymer or coated with a thermoset resin. Extrusion, injection molding, the curing of a thermoset resin, and other methods for processing polymers require the formation of a melt at elevated temperatures substantially above a heat labile component's decomposition or volatilization temperature. Additionally, the ability to form a device having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous coatings, oil base coatings, or powder coatings and can be applied and cured, when necessary, according to procedures known in the art. Powder coatings are particularly useful for coating large devices, particularly large metal devices. Component/carrier combinations can be included during the preparation of the surface treatment or included in the formulation just prior to its application.

A variety of heat labile components and/or incompatible components can be incorporated into the surface of a variety of devices having a range of features, shapes, and uses. The surfaces can be external, internal, or a combination thereof. The device's surfaces can be formed in a number of ways known in the art and described herein. Each device or device surface can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of device surfaces contemplated include, but are not limited to solid surfaces, mesh surfaces, porous surfaces, and the like. Device surfaces containing a heat labile component/carrier combination can remain sterile, kill microorganisms and the like upon contact, and prevent the spread of microorganisms though serial contact. Device surfaces containing a repellent, such as an animal and/or insect repellent, can maintain a region about the surface free of animals, insects and the like. A device's surface containing an insecticide can kill insects sensitive to the insecticide utilized that contact the surface. A device's surface containing a combination pheromone/insecticide can attract pheromone sensitive insects and upon contacting the surface kill insects sensitive to the insecticide utilized.

### Woven and Non-Woven Fabrics:

Fabric refers to any textile material made through knitting, weaving, braiding, or plaiting and bonding of fibers. Fabric can be classified in a variety of ways. Based on its fiber, it can be considered a natural fabric, such as cashmere, cotton, hemp, jute, linen, ramie, silk, wool or a synthetic or man-made fabric such as acetate, acrylic, chiffon, denim, georgette, yarns that have an elastic core wound around with cotton or silk or nylon or rayon threads, nylon, organza, polyester fabrics, rayon, satin, velvet and the like. A fabric can also be classified based on its end use such as a fabric for making apparel, curtains, drapery, home furnishing, quilting, upholstery among others. Other fabrics classified based on end use include abrasive, aluminized, awning, blended, carbon, fiberglass, flame resistant, narrow, tarpaulin, vinyl fabric and the like. The traditional methods of manufacturing fabrics include weaving, knitting and braiding. Other more unconventional methods include bonding fibers by mechanical, thermal, chemical or solvent means.

Weaving involves the inter-lacing, usually at right angles, of two sets of threads to form cloth, rug or other types of woven textiles. Today's weaving processes are mostly automated for mass production. The process utilizes two distinct sets of yarns, one called the warp and the other the filling or weft, which are interlaced with each other to form a fabric. The lengthwise yarns run from the back to the front of the loom are called the warp. The crosswise yarns are the filling or weft. The fabric is produced in a loom, which holds the warp threads in place while the filling threads are woven through them.

Knitting is the next most common form of fabric construction. The yarn in knitted fabrics follows a meandering path, forming symmetric loops or stitches. When the interlocking loops run lengthwise, each row is called a wale. A wale can be compared with the warp in weaving. A row of loops running across the fabric are called a course. A course corresponds to the filling, or weft in weaving. The two most common varieties of knitting are weft knitting and warp knitting. In weft knitting, a continuous yarn forms courses across the fabric, whereas, in warp knitting, a series of yarns form wales in the lengthwise direction of the fabric.

A braid resembles a rope, which is made by interweaving three or more strands, strips, or lengths, in a diagonally overlapping pattern. Braiding is a major fabrication method for composite reinforcement fabrics where strength is important. Braiding developed from a domestic art of making laces. There are two forms of braiding: two and three-dimensional braiding.

Nonwoven fabrics can be made by bonding or interlocking fibers or filaments by mechanical, thermal, chemical or solvent means. In order to make staple non-woven's, fibers are first spun, cut to a few centimeters length, and baled. Fibers from the bales are scattered on a conveyor belt, and spread in a uniform web by a wetlaid process or by a carding process. Nonwovens prepared in this manner can either be bonded thermally or with a resin. Spunlaid non-woven's can be made in one continuous process, wherein the fibers are spun and directly dispersed into a web by deflectors or with air streams. Meltblown nonwovens have extremely fine fiber diameters and have less strength. Spunlaid nonwovens are bonded either thermally or with a resin. Without the bonding step, both staple and spunbonded non-wovens would have no mechanical resistance.

Nonwoven fabrics are utilized in various industrial applications along with medical, personal care, hygiene and household applications. They are used in interlinings and apparel; carpet backing and underlay; needle punched felt for backing of PVC floor covering; home furnishing and household products; medical, sanitary, and surgical applications; book cloths; industrial wiping cloths; filtration; shoe linings; automotive applications; laundry & carry bags in hospitality industry and many additional applications.

Nonwoven fabrics are broadly defined as sheet or web structures bonded together by mechanical, thermal or chemical induced entanglement of fiber or filaments. The web structures are flat, porous sheets made directly from separate fibers or from molten polymer or polymer film. They are not made by weaving or knitting and do not require converting the fibers to yarn. Commonly, recycled fabrics and other oil-based materials can be transformed into nonwoven fabrics. As a result, nonwoven fabrics are often considered a more ecological fabric for certain applications, especially in fields and industries where disposable or single use products are important, such as hospitals, schools, nursing homes, and luxury accommodations.

Nonwoven fabrics are engineered fabrics which can be suitable for a range of uses, such as a limited life, a single-use fabric or a very durable multi-use fabric. Nonwoven fabrics can exhibit absorbency, liquid repellence, resilience, stretch, softness, strength, flame retardancy, washability, cushioning, filtering. Non woven fabrics can mimic the appearance, texture and strength of a woven fabric and can be sufficiently bulky to serve as a pad. Alone or in combination with other materials nonwoven fabrics provide a spectrum of products with diverse properties. When used alone they can function as components of apparel, home furnishings, health care, engineering, industrial and consumer goods. Non-woven materials are used in numerous applications, including: disposable diapers, sanitary napkins, tampons, sterile wraps, caps, gowns, masks and drapings used in the medical field, household and personal wipes, laundry aids (fabric dryer sheets), apparel interlining, carpeting and upholstery fabrics, padding, and backing, wall coverings, agricultural coverings, seed strips, automotive headliners and upholstery, filters, envelopes, tags, labels, insulation, house wraps, roofing products, civil engineering fabrics, and geotextiles.

Because both nonwoven and woven fabrics made from synthetic fabrics involve a processing stage that includes a molten polymer, a variety of heat labile components cannot be incorporated into the fabrics. Similarly, combinations of incompatible components cannot be included. As a result, woven and nonwoven fabrics are left without a substantial number of desirable properties.

A fabric exposed to environments resulting in multiple contacts can become contaminated and the vehicle for the spread of communicable disease and infections. The inclusion of an appropriate biocide into the fabric can provide a fabric able to both kill and prevent colonization of microorganisms on its surface. Similarly, a fabric containing an insect repellent incorporated into an article of clothing can protect the wearer from attack by insects responsive to the repellent. In the same way, replacement of the repellent with an appropriate enzyme can protect the wearer of the clothing from a variety of pesticides, nerve gas components and the like contacted.

Fabrics can be constructed entirely from polymers or in part from polymers by utilizing a polymer laminate, a film, or a coating derived from a surface treatment. For example, carpet backing derived from a synthetic nonwoven polymeric fabric can be bonded to a variety of synthetic and natural carpet materials.

Both nonwoven fabric and synthetic fibers utilized to make woven fabrics are typically processed through a melt cycle followed by extrusion and in some cases further heat treatment to increase the fabric's strength. These separate cycles can require a polymer or an initially formed structure to experience temperatures above the polymers melting temperature or its softening point, both of which typically exceed a heat labile component's decomposition or volatilization temperature. Additionally, the ability to form a fabric having a surface that exhibits a combination of bacteriocidal, viruscidal, and/or fungicidal properties requires several components which, in addition to being heat labile, can be incompatible; reacting or precipitating when combined. The presence of the heat labile component/carrier combination and/or incompatible component/carrier combinations within the polymer does not generally change the polymer's appearance or most typical physical properties.

As noted above, surface treatments can be applied to the woven and nonwoven fabrics and include formulations in the form of paints, coatings, stains, varnishes, sealants, films, inks, and the like. The treatments can be formulated as aqueous, oil base, thermoplastic, or thermoset and can be applied and cured, when necessary, according to procedures known in the art. Component/carrier combinations can be included during the preparation of the surface treatment or included in the formulation just prior to its application.

The inclusion of the components taught herein into woven and nonwoven fabrics can cause the new fabrics to exhibit a range of important properties which include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. The treated fabrics can be porous, nonporous, or mesh. Fabrics constructed according to this disclosure can remain sterile, kill microorganisms and the like upon contact, and prevent the spread of microorganisms though serial contact. Fabric surfaces containing a repellent, such as an animal and/or insect repellent, can maintain a region about the fabric free of animals, insects and the like. For example, a tent constructed from a nonwoven fabric containing an animal repellent would be able to provide a region about the constructed tent generally free of that animal. A fabric's surface containing an insecticide can kill insects sensitive to the insecticide utilized that contact the fabric. A fabric's surface containing a combination pheromone/insecticide can attract pheromone sensitive insects and upon contacting the fabric kill insects sensitive to the insecticide utilized.

### Remediation Materials:

A remediation material protects a region of the environment or its inhabitants from damage or injury caused by macro and microorganisms; weather related effects, including water, wind, drought; and the like. Additionally, a remediation material improves a region of the environment. Some remediation materials include biodegradable polymers that are broken down into materials compatible with the environment over time. Other remediation materials include non-biodegradable polymers to provide long term service requirements. In addition, some remediation materials can include a combination of biodegradable and non-biodegradable polymers.

In the discussion that follows, several examples are provided of remediation materials including a heat labile component/carrier combination; a combination of incompatible components adsorbed on separate carriers; and/or combinations thereof. These are provided as examples of representative and/or illustrative remediation materials, and in no way is intended to restrict the present disclosure to just these examples. After providing examples of remediation materials, the materials and methods for their preparation are described.

Biodegradable polymers, such as for example, super adsorbent polymer (SAP's) derived from a range of monomers including, but not limited to acrylic acid and its derivatives, starch, and cellulose have proven useful in the agricultural field. The SAP's have the ability to absorb 300 to 1000 times their weight of water. Soil containing SAP's can, during wet periods hold moisture without causing the roots of plants growing therein from rotting. In addition, if the weather turns dry, the moisture contained in the SAP is slowly released to assist the plant through a dry period. Such SAP's are also utilized as seed coatings, providing moisture to assist germination without causing the seed to rot. Currently some SAP's are biodegradable, while others are not. By tailoring the SAP with a biocide combination in selected amounts, biodegradable SAP's can be prepared that can have a programmed life, degrading over 1 month, 6 months, 1 year, 5 years, or more. In addition, insecticides and/or fungicides can be included which will be released during the SAP's programmed decomposition. By tying the component's release to the rate of the SAP's decomposition, a controlled release of the component can be achieved. Such ability to deliver an agricultural product during a critical time in the growing period can substantially increase yields and reduce the cost of repeated applications. The ability to provide a controlled release of a variety of pesticides can also be important in products designed for home and yard maintenance.

Non-biodegradable polymers can similarly be loaded with a variety of pesticides loaded in carriers. Each particle acts as a container for the pesticide, protecting it from microorganisms, moisture and the like, capable of delivering an effective amount of the pesticide to its surface where contact by an insect, or other pest can be lethal. Because small particles have extremely large surface areas, their incorporation into the soil can result in sufficient contacts with insects and the like to effectively control their numbers within a protected region. In addition, the protection afforded the pesticide within the polymer particle can extend the pesticide's effective life. The current banning of chlorinated pesticides such as chlorodane, pentachlorophenol, and the like has left homes either subject to attack by termites and/or carpenter ants or requires repeated treatments with pesticides providing a short effective service. The incorporation of pesticides into remediation materials can extend the pesticides effective life and can make their use substantially less hazardous to those handling the materials. In addition, the level of pesticide released to the environment over a given time period is also substantially reduced. In one instance, the foundation of a home can be provided with a barrier that includes a remediation material containing a termaticide during construction, or a barrier can be provide to an existing home by at least partially exposing the foundation or perimeter of the home. These remediation materials can be used to protect homes built on a basement, a crawl space, or a concrete slab.

Remediation materials also include geotextiles used for a variety of purposes to manage and improve the environment. Geotextiles typically include a permeable textile material used to increase soil stability, provide erosion control, and/or control drainage. Geotextiles can be woven or nonwoven fabrics derived from natural or synthetic materials. Such materials can take the form of a matt, a web, a net, a grid or a sheet, depending on its purpose. The purpose served by a geotextile can be short or long term, depending on the need and its materials of construction. Geotextiles are generally buried in the ground at varying depths. For example, turf reinforcements can be constructed from polyolefin fibers. Application of the turf reinforcement allows grass or other plants to grow through it, water readily penetrates and flows across its surface or into the soil, and stability is provided when the surface is subject to traffic. Such turf reinforcements can benefit with the incorporation of insecticides, fungicides, and selective herbicides to protect the turf from grubs and other insects, fungi, and broadleaf weed and/or undesirable grasses. These components can be readily introduced into the turf reinforcement's fibers by means of one or more pesticide/carrier combinations.

Other geotextiles are utilized in the construction of roads, buildings, and the like where the materials are placed below the ground to direct the flow of water passing through the soil. Such geotextiles primarily suffer failure because of ruptures that develop within the fabric. Such failures typically occur because of burrowing animals, or rupture caused by tree roots. The incorporation of a rodenticide or an appropriate repellant can reduce the frequency of failure of the remediation material caused by burrowing animals. The incorporation of an appropriate agent such as a herbicide can prevent roots from penetrating the remediation material.

Finally, remediation materials can be dispersed into fresh water to prevent a host of diseases, and related injuries caused by a range of microorganisms. For example, Shistosomiasis is caused by exposure to atypical trematodes found in fresh water and soil. Past efforts to eradicate or control the trematode population has involved the use of DDT, pentaclorophenol, and more recently organophosphorus insecticides such as Profenophos. These materials each have adverse effects on the environment when the pesticides are broadcast or sprayed into the fresh water environment. The incorporation of a pesticide/carrier combination into a remediation material, in the form of a particle, a sheet, a net, or the like which can be appropriately placed in fresh water can control the trematode population without adversely affecting the fresh water environment.

The preceding examples were provided as illustrations of remediation materials which can benefit from the incorporation of a component/carrier combination into the polymer utilized to prepare the remediation material. The following discussion considers examples of materials which can be utilized, and components with can be selected to impart particular properties into the remediation material. Again, these examples are illustrative, and not intended to be limiting.

Constructing remediation materials with these properties utilizing standard methods has proven problematic. A majority of the components needed to impart the desired properties are heat labile and decompose or volatilize under conditions normally required to construct a remediation material. Further in some instances, during their use or installation, the remediation materials can become exposed to elevated temperatures causing decomposition of any heat labile components incorporated therein. When a component of within a remediation material's surface decomposes, any properties associated with that component are no longer expressed. In other instances, the remediation material experiences exposure to elevated temperatures during its service, that causes decomposition or volatilization. In addition, when a plurality of components (some of which can be heat labile components) is utilized to provide one or more properties, the necessary components often cannot be combined because one or more of the components are incompatible, that is they react, precipitate, or otherwise interfere with the formulations preparation. As a result, the formulation cannot exhibit the desired combination of properties.

Remediation materials can be constructed entirely from polymers or in part from polymers by utilizing a polymer laminate, a film, or a coating derived from a surface treatment. For example, a geotextile fabric can be prepared from several layers of polymer forming a laminate with or without a coating derived from a surface treatment such as a thermoset resin. Extrusion, injection molding, the curing of a thermoset resin, and other methods for processing polymers require the formation of a melt at elevated temperatures substantially above a heat labile component's decomposition or volatilization temperature. Additionally, the ability to form a remediation material having a surface that exhibits a combination of bacteriocidal, viruscidal, and/or fungicidal properties requires several components which, in addition to being heat labile, can be incompatible; reacting or precipitating when combined.

As noted above, surface treatments can include formulations in the form of paints, coatings, stains, varnishes, sealants, films, inks, and the like. The treatments can be formulated as aqueous coatings, oil base coatings, or powder coatings and can be applied and cured, when necessary, according to procedures known in the art. Component/carrier combinations can be included during the preparation of the surface treatment or included in the formulation just prior to its application.

A variety of heat labile components and/or incompatible components can be incorporated into the surface of a variety of remediation materials having a range of features, shapes, and uses. The surfaces can be external, internal, or a combination thereof. The remediation material's surfaces can be formed in a number of ways known in the art and described herein. Each remediation material or material surface can be created utilizing standard manufacturing equipment from a molten polymer, and its ability to exhibit properties derived from or related to the heat labile component that could not be achieved without the utilization of the heat labile component/carrier combination. The presence of the heat labile component/carrier combination and/or incompatible component/carrier combinations within the polymer does not generally change the polymer's appearance or typical physical properties. The properties exhibited include, but are not limited to bactericidal activity, fungicidal activity, viruscidal activity, herbicidal activity, insecticidal activity, acaricidal activity, miticidal activity, algicidal properties enzymatic activity, repellent properties, fragrant properties (including pheromones), and combinations thereof. Examples of remediation material surfaces contemplated include, but are not limited to solid surfaces, mesh surfaces, porous surfaces, and the like. Remediation material surfaces containing a heat labile component/carrier combination can remain sterile, kill microorganisms and the like upon contact, and prevent the spread of microorganisms though serial contact. Remediation material surfaces containing a repellent, such as an animal and/or insect repellent, can maintain a region about the surface generally free of animals, insects and the like. A remediation material's surface containing an insecticide can kill insects sensitive to the insecticide utilized that contact the surface. A remediation material's surface containing a combination pheromone/insecticide can attract pheromone sensitive insects and upon contacting the surface kill insects sensitive to the insecticide utilized.

### Methods for Preparing Polymer for Surfaces and Members Having Surfaces:

Broadly considered, the method disclosed herein, generally involves subjecting a heat labile component to a processing step carried out at processing temperatures above the component's transformation temperature, a temperature at which the component will become subject to inactivation volatilization, decomposition, a chemical reaction, or combinations thereof. Transformation of the heat labile component is avoided by first adsorbing the heat labile component onto a carrier prior to processing and by limiting the processing time. Suitable carriers are stable to the processing conditions and have the ability to load sufficient heat labile component, necessary for a particular application. The method generally provides for combinations including one or more heat labile components that could not otherwise be processed without decomposition and or which are incompatible with each other or other components. For example, some heat labile biocides are incompatible and can react, form a precipitate, slime, and the like. For such incompatible biocides, a single heat labile biocide should be added to a single carrier. Additional otherwise incompatible materials can more readily be handled and incorporated into the polymer by first being loaded into a carrier. Combinations of single biocide/carrier combinations can and have been combined in a masterbach material and extruded into polymer sheets without further evidence of incompatibility.

Heat labile components additionally involve materials that are volatile at a polymer's processing temperature and unless incorporated into a carrier. Incorporation of the volatile component into a carrier prior to incorporation into the polymer prevents substantial volatilization during processing. Volatile fragrances loaded into a carrier have been successfully incorporated into a range of polymers without decomposition or volatilization. The resulting polymer articles were capable of emitting the fragrance over a long period of time. Attempts to incorporate the fragrance into a polymer without being loaded into a carrier resulted in both volatilization and decomposition. Additionally, volatile materials such as animal and insect repellants can be successfully loaded into polymers without decomposition or volatilization to provide combinations capable of repelling animals and/or insects for long periods of time.

In the discussion which follows, specific compositions and methods will be described with regard to one or more heat labile components, such as biocides. It is understood that other heat labile materials discussed herein can be utilized similarly to provide a variety of solids from a molten phase which contain the other heat labile materials distributed throughout the solid.

A first aspect of the present disclosure involves a method for the incorporation of a heat labile component such as a biocide into a polymer phase at temperatures above the biocide's decomposition temperature without substantially decomposing the biocide or interfering with its properties. Prior to incorporation, the biocide is adsorbed onto a suitable carrier. Suitable carriers are generally unreactive porous materials capable of remaining solid at any necessary processing temperatures. Incorporation of the biocide/carrier combination into a polymer or other molten mass is carried out in a manner that minimizes the time the biocide/carrier combination is subjected to temperatures greater than the biocide's decomposition temperature. The processing temperature is typically determined by the properties of the polymer phase and the nature of the processing step. Once a processing temperature has been determined, combinations of polymer/carrier/biocide can be provided and maintained at that temperature for varying amounts of time to determine a maximum processing time. The modified polymers that result from this process typically exhibit additional properties derived from the heat labile component. The modified polymers contain surfaces that can be incorporated into members that include structures, articles, containers, devices, woven/nonwoven articles, remediation materials, and the like which similarly and advantageously exhibit the additional properties.

### Polymers:

Based on testing carried out at this time, polymers have had a glass transition temperature (or melting temperature) of at least 100° C. and more typically ranging from about 180° C. to about 550° C. At or above these temperatures the preferred polymers form a viscous liquid to which a biocide/carrier combination can be added and mixed during initial processing. Such polymers include, but are not limited to organic polymers, inorganic polymers, mixtures of organic and inorganic polymers, copolymers including mixed organic/inorganic polymers, linear polymers, branched polymers, star polymers, and mixtures thereof. A specific polymer or polymer combination is typically selected to provide the necessary physical properties for an application at an acceptable cost.

Polymers generally suitable for processing according to the current disclosure include, but are not limited to:

1. Polymers of monoolefins and diolefins, for example polypropylene, polyisobutylene, polybut-1-ene, poly-4-methylpent-1-ene, polyisoprene or polybutadiene, as well as polymers of cycloolefins, for instance of cyclopentene or norbornene, polyethylene (which optionally can be crosslinked), for example high density polyethylene (HDPE), low density polyethylene (LDPE), linear low density polyethylene (LLDPE), branched low density polyethylene (BLDPE) and medium density polyethylene (MDPE). Polyolefins, i.e. the polymers of monoolefins exemplified in the preceding paragraph, preferably polyethylene and polypropylene, can be prepared by different, and especially by the following, methods:
a) radical polymerization (normally under high pressure and at elevated temperature).
b) catalytic polymerization using a catalyst that normally contains one or more than one metal of groups IVb, Vb, VIb or VIII of the Periodic Table.
   These metals usually have one or more than one ligand, typically oxides, halides, alcoholates, esters, ethers, amines, alkyls, alkenyls and/or aryls that may be either p- or s-coordinated. These metal complexes may be in the free form or fixed on substrates, typically on activated magnesium chloride, titanium(III) chloride, alumina or silicon oxide. These catalysts may be soluble or insoluble in the polymerization medium. The catalysts can be used by themselves in the polymerization or further activators may be used, typically metal alkyls, metal hydrides, metal alkyl halides, metal alkyl oxides or metal alkyloxanes, said metals being elements of groups Ia, IIa and/or IIIa of the Periodic Table. The activators may be modified conveniently with further ester, ether, amine or silyl ether groups. These catalyst systems are usually termed Phillips, Standard Oil Indiana, Ziegler (-Natta), TNZ (DuPont), metallocene or single site catalysts (SSC).

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of monoolefins and diolefins with each other or with other vinyl monomers, for example ethylene/propylene copolymers, linear low density polyethylene (LLDPE) and mixtures thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and their copolymers with carbon monoxide or

ethylene/acrylic acid copolymers and their salts (ionomers) as well as terpolymers of ethylene with propylene and a diene such as hexadiene, dicyclopentadiene or ethylidene-norbornene; and mixtures of such copolymers with one another and with polymers mentioned in 1) above, for example polypropylene/ethylene-propylene copolymers, LDPE/ethylene-vinyl acetate copolymers (EVA), LDPE/ethylene-acrylic acid copolymers (EM), LLDPE/EVA, LLDPE/EM and alternating or random polyalkylene/carbon monoxide copolymers and mixtures thereof with other polymers, for example polyamides.

4. Hydrocarbon resins (for example C₅-C₉) including hydrogenated modifications thereof (e.g. tackifiers) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/unsaturated ester, styrene/acrylonitrile, styrene/alkyl methacrylate, styrene/butadiene/alkyl acrylate, styrene/butadiene/alkyl methacrylate, styrene/maleic anhydride, styrene/acrylonitrile/methyl acrylate; mixtures of high impact strength of styrene copolymers and another polymer, for example a polyacrylate, a diene polymer or an ethylene/propylene/diene terpolymer; and block copolymers of styrene such as styrene/butadiene/styrene, styrene/isoprene/styrene, styrene/ethylene/butylene/styrene or styrene/ethylene/propylene/styrene.

7. Graft copolymers of styrene or α-methylstyrene, for example styrene on polybutadiene, styrene on polybutadiene-styrene or polybutadiene-acrylonitrile copolymers; styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleimide on polybutadiene; styrene and maleimide on polybutadiene; styrene and alkyl acrylates or methacrylates on polybutadiene; styrene and acrylonitrile on ethylene/propylene/diene terpolymers; styrene and acrylonitrile on polyalkyl acrylates or polyalkyl methacrylates, styrene and acrylonitrile on acrylate/butadiene copolymers, as well as mixtures thereof with the copolymers listed under 6), for example the copolymer mixtures known as ABS, SAN, MBS, ASA or AES polymers.

8. Halogen-containing polymers such as polychloroprene, chlorinated rubbers, chlorinated or sulfochlorinated polyethylene, copolymers of ethylene and chlorinated ethylene, epichlorohydrin homo- and copolymers, especially polymers of halogen-containing vinyl compounds, for example polyvinyl chloride, polyvinylidene chloride, polyvinyl fluoride, polyvinylidene fluoride, as well as copolymers thereof such as vinyl chloride/vinylidene chloride, vinyl chloride/vinyl acetate or vinylidene chloride/vinyl acetate copolymers.

9. Polymers derived from α,β-unsaturated acids and derivatives thereof such as polyacrylates and polymethacrylates; polymethyl methacrylates, polyacrylamides and polyacrylonitriles, impact-modified with butyl acrylate.

10. Copolymers of the monomers mentioned under 9) with each other or with other unsaturated monomers, for example acrylonitrile/butadiene copolymers, acrylonitrile/alkyl acrylate copolymers, acrylonitrile/alkoxyalkyl acrylate or acrylonitrile/vinyl halide copolymers or acrylonitrile/alkyl methacrylate/butadiene terpolymers.

11. Polymers derived from unsaturated alcohols and amines or the acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallyl melamine; as well as their copolymers with olefins mentioned in 1) above.

12. Homopolymers and copolymers of cyclic ethers such as polyalkylene glycols, polyethylene oxide, polypropylene oxide or copolymers thereof with bis-glycidyl ethers.

13. Polyacetals such as polyoxymethylene and those polyoxymethylenes which contain ethylene oxide as a comonomer; polyacetals modified with thermoplastic polyurethanes, acrylates or MBS.

14. Polyphenylene oxides and sulfides, and mixtures of polyphenylene oxides with styrene polymers or polyamides.

15. Polyurethanes derived from hydroxyl-terminated polyethers, polyesters or polybutadienes on the one hand and aliphatic or aromatic polyisocyanates on the other, as well as precursors thereof.

16. Polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylene diamine and adipic acid; polyamides prepared from hexamethylenediamine and isophthalic or/and terephthalic acid and with or without an elastomer as modifier, for example poly-2,4,4,-trimethylhexamethylene terephthalamide or poly-m-phenylene isophthalamide; and also block copolymers of the aforementioned polyamides with polyolefins, olefin copolymers, ionomers or chemically bonded or grafted elastomers; or with polyethers, e.g. with polyethylene glycol, polypropylene glycol or polytetramethylene glycol; as well as polyamides or copolyamides modified with EPDM or ABS; and polyamides condensed during processing (RIM polyamide systems).

17. Polyureas, polyimides, polyamide-imides and polybenzimidazoles.

18. Polyesters derived from dicarboxylic acids and diols and/or from hydroxycarboxylic acids or the corresponding lactones, for example polyethylene terephthalate, polytrimethylene terephthalate, polybutylene terephthalate, poly-1,4-dimethylolcyclohexane terephthalate and polyhydroxybenzoates, as well as block copolyether esters derived from hydroxyl-terminated polyethers; and also polyesters modified with polycarbonates or MBS. Polyesters and polyester copolymers as defined in U.S. Pat. No. 5,807,932 (column 2, line 53), incorporated herein by reference.

19. Polycarbonates and polyester carbonates.

20. Polysulfones, polyether sulfones and polyether ketones.

21. Crosslinked polymers derived from aldehydes on the one hand and phenols, ureas and melamines on the other hand, such as phenol/formaldehyde resins, urea/formaldehyde resins and melamine/formaldehyde resins.

22. Drying and non-drying alkyd resins.

23. Unsaturated polyester resins derived from copolyesters of saturated and unsaturated dicarboxylic acids with or without halogen-containing modifications thereof of low flammability.

24. Crosslinkable acrylic resins derived from substituted acrylates, for example epoxy acrylates, urethane acrylates or polyester acrylates.

25. Alkyd resins, polyester resins and acrylate resins crosslinked with melamine resins, urea resins, polyisocyanates or epoxy resins.

26. Epoxy resins derived from polyepoxides, for example from bis glycidyl ethers or from cycloaliphatic diepoxides.

27. Natural polymers such as cellulose, rubber, gelatin and chemically modified homologous derivatives thereof, for example cellulose acetates, cellulose propionates and cellulose butyrates, or the cellulose ethers such as methyl cellulose; as well as rosins and their derivatives.

28. Blends of the aforementioned polymers (polyblends), for example PP/EPDM, Polyamide/-EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO.

29. Naturally occurring and synthetic organic materials which are pure monomeric compounds or mixtures of such compounds, for example mineral oils, animal and vegetable fats, oil and waxes, or oils, fats and waxes based on synthetic esters (e.g. phthalates, adipates, phosphates or trimellitates) and also mixtures of synthetic esters with mineral oils in any weight ratios, typically those used as spinning compositions, as well as aqueous emulsions of such materials.

30. Aqueous emulsions of natural or synthetic rubber, e.g. natural latex or latices of carboxylated styrene/butadiene copolymers.

31. Polysiloxanes such as the soft, hydrophilic polysiloxanes described, for example, in U.S. Pat. No. 4,259,467; and the hard polyorganosiloxanes described, for example, in U.S. Pat. No. 4,355,147.

32. Polyketimines in combination with unsaturated acrylic polyacetoacetate resins or with unsaturated acrylic resins. The unsaturated acrylic resins include the urethane acrylates, polyether acrylates, vinyl or acryl copolymers with pendant unsaturated groups and the acrylated melamines. The polyketimines are prepared from polyamines and ketones in the presence of an acid catalyst.

33. Radiation curable compositions containing ethylenically unsaturated monomers or oligomers and a polyunsaturated aliphatic oligomer.

34. Epoxymelamine resins such as light-stable epoxy resins crosslinked by an epoxy functional coetherified high solids melamine resin such as LSE-4103 (Monsanto).

Resins that do not have a glass transition temperature because of cross-linking or for other reasons can be incorporated by mixing with another polymer having a glass transition temperature within a necessary temperature range.

The following polymers are particularly suitable for this application: polyvinylchloride, thermoplastic elastomers, polyurethanes, high density polyethylene, low density polyethylene, silicone polymers, fluorinated polyvinylchloride, polystyrene, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Depending on the biocide concentration, cooling and solidification of the resulting polymer/biocide composition can provide a product ranging from a concentrate (a “masterbatch”) for subsequent incorporation into additional polymer or a finished article.

The carrier/biocide combination can also be incorporated into thermoset resins that reach elevated temperatures while curing. When the carrier/biocide combination is exposed to the curing temperatures, the biocide does not undergo transformation and imparts its biocidal properties to the cured thermoset resin. Examples of thermoset resins which can be loaded with the carrier;/biocide combination include, but are not limited to vinyl plastisol, polyesters, epoxy resin, polyurethanes, urea formaldehyde resins, vulcanized rubber, melamine, polyimide, and resins derived from various acrylated monomers & oligomers of epoxy, urethane, arylic, and the like commonly used to formulate UV curable systems.

### The Biocides and Related Heat Labile Components:

Biocides utilized according to the present disclosure are generally biocides which have reduced stability when exposed to required processing conditions at temperatures above their decomposition temperature. A majority are biocides which have limited heat stability that prevent their incorporation into polymers by standard methods.

Biocides generally suitable for processing according to the current disclosure include, but are not limited to: Acetylcarnitine, Acetylcholine, Aclidinium bromide, Acriflavinium chloride, Agelasine, Aliquat 336, Ambenonium chloride, Ambutonium bromide, Aminosteroid, Anilinium chloride, Atracurium besilate, Benzalkonium chloride, Benzethonium chloride, Benzilone, Benzododecinium bromide, Benzoxonium chloride, Benzyltrimethylammonium fluoride, Benzyltrimethylammonium hydroxide, Bephenium hydroxynaphthoate, Berberine, Betaine, Bethanechol, Bevonium, Bibenzonium bromide, Bretylium, Bretylium for the treatment of ventricular fibrillation, Burgess reagent, Butylscopolamine, Butyrylcholine, Candocuronium iodide, Carbachol, Carbethopendecinium bromide, Carnitine, Cefluprenam, Cetrimonium, Cetrimonium bromide, Cetrimonium chloride, Cetylpyridinium chloride, Chelerythrine, Chlorisondamine, Choline, Choline chloride, Cimetropium bromide, Cisatracurium besilate, Citicoline, Clidinium bromide, Clofilium, Cocamidopropyl betaine, Cocamidopropyl hydroxysultaine, Complanine, Cyanine, Decamethonium, 3-Dehydrocarnitine, Demecarium bromide, Denatonium, Dequalinium, Didecyldimethylammonium chloride, Dimethyldioctadecylammonium chloride, Dimethylphenylpiperazinium, Dimethyltubocurarinium chloride, DiOC6, Diphemanil metilsulfate, Diphthamide, Diquat, Distigmine, Domiphen bromide, Doxacurium chloride, Echothiophate, Edelfosine, Edrophonium, Emepronium bromide, Ethidium bromide, Euflavine, Fenpiverinium, Fentonium, Gallamine triethiodide, Gantacurium chloride, Glycine betaine aldehyde, Glycopyrrolate, Guar hydroxypropyltrimonium chloride, Hemicholinium-3, Hexafluoronium bromide, Hexamethonium, Hexocyclium, Homatropine, Hydroxyethylpromethazine, Ipratropium bromide, Isometamidium chloride, Isopropamide, Jatrorrhizine, Laudexium metilsulfate, Lucigenin, Mepenzolate, Methacholine, Methantheline, Methiodide, Methscopolamine, Methylatropine, Methylscopolamine, Metocurine, Miltefosine, MPP+, Muscarine, Neurine, Obidoxime, Otilonium bromide, Oxapium iodide, Oxyphenonium bromide, Palmatine, Pancuronium bromide, Pararosaniline, Pentamine, Penthienate, Pentolinium, Perifosine, Phellodendrine, Phosphocholine, Pinaverium, Pipecuronium bromide, Pipenzolate, Poldine, Polyquaternium, Pralidoxime, Prifinium bromide, Propantheline bromide, Prospidium chloride, Pyridostigmine, Pyrvinium, Quaternium-15, Quinapyramine, Rapacuronium, Rhodamine B, Rocuronium bromide, Safranin, Sanguinarine, Stearalkonium chloride, Succinylmonocholine, Suxamethonium chloride, Tetra-n-butylammonium bromide, Tetra-n-butylammonium fluoride, Tetrabutylammonium hydroxide, Tetrabutylammonium tribromide, Tetraethylammonium, Tetraethylammonium bromide, Tetramethylammonium chloride, Tetramethylammonium hydroxide, Tetramethylammonium pentafluoroxenate, Tetraoctylammonium bromide, Tetrapropylammonium perruthenate, Thiazinamium metilsulfate, Thioflavin, Thonzonium bromide, Tibezonium iodide, Tiemonium iodide, Timepidium bromide, Trazium, Tridihexethyl, Triethylcholine, Trigonelline, Trimethyl ammonium compounds, Trimethylglycine, Trolamine salicylate, Trospium chloride, Tubocurarine chloride, Vecuronium bromide.

Preferred heat labile biocides include, but are not limited to, quaternary amines and antibiotics. Some specific preferred heat labile biocides include, but are not limited to, N,N-didecyl-N-methyl-N-(3-trimethoxysilylpropyl)ammonium chloride, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride.

Some specific antibiotics include, but are not limited to amoxicillin, campicillin, piperacillin, carbenicillin indanyl, methacillin cephalosporin cefaclor, streptomycin, tetracycline and the like. Preferred combinations of biocides generally include at least one heat labile biocide, which would not survive incorporation into a specific polymer unless adsorbed onto a carrier. Examples of preferred fungicides include iodopropynylbutylcarbamate; N-[(trichloromethyl)thio]phthalimide; and chlorothalonil. Examples of preferred bactericides include benzisothiazolinone and 5-chloro-2-methyl-4-isothiazolin-3-one. Other biocides which can be utilized according to this disclosure include, but are not limited to, bactericides, fungicides, algicides, miticides, viruscides, insecticides, acaracides, molluscicidies herbicides rodenticides, animal and insect repellants, and the like.

### The Carriers:

Suitable carriers are typically porous materials capable of adsorbing the heat labile biocide, remaining in a solid form without decomposition during processing in a molten phase, and maintaining the biocide in the adsorbed state during processing. Carriers having a substantial porosity and a high surface area (mostly internal) are suitable. A further useful property for a carrier is a relatively low thermal conductivity. Finally, for some applications, carriers which do not alter the color or appearance of the polymer are particularly suitable.

Carriers which have been utilized include, but are not limited to, inorganics such as platy minerals and polymers. Examples of inorganics include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized. Polymeric carriers should remain solid at elevated temperatures and be capable of loading sufficient quantities of biocide either into a pore system or through other means of incorporation. Suitable polymeric carriers include, but are not limited to, organic polymeric carriers such as cross-linked macroreticular and gel resins, and combinations thereof such as the so-called plum pudding polymers. Further suitable carriers include organic polymeric carriers include porous macroreticular resins, some of which can include other resins within the polymer's structure. Suitable resins for imbedding within a macroreticular resin include other macroreticular resins or gel resins. Additionally, other porous non-polymeric materials such as minerals can similarly be incorporated within the macroreticular resin.

Suitable organic polymeric carriers can include polymers lacking a functional group, such as a polystyrene resin, or carriers having a functional group such as a sulfonic acid included. Generally, any added functional group should not substantially reduce the organic polymeric carrier's thermal stability. A suitable organic polymeric carrier should be able to load a sufficient amount of biocide, and survive any processing conditions, and deliver an effective amount of the heat labile component such as a biocide upon incorporation into any subsequent system. Suitable organic polymeric carriers can be derived from a single monomer or a combination of monomers. Combinations of inorganic and organic carriers can be utilized.

General methods for preparing macroreticular and gel polymers are well known in the art utilizing a variety of monomers and monomer combinations. Suitable monomers for the preparation of organic polymeric carriers include, but are not limited to styrene, vinyl pyridines, ethylvinylbenzenes, vinyltoluenes, vinyl imidazoles, an ethylenically unsaturated monomers, such as, for example, acrylic ester monomers including methyl acrylate, ethyl acrylate, butyl acrylate, 2-ethylhexyl acrylate, decyl acrylate, methyl methacrylate, butyl methacrylate, lauryl (meth)acrylate, isobornyl (meth)acrylate, isodecyl (meth)acrylate, oleyl (meth)acrylate, palmityl (meth)acrylate, stearyl (meth)acrylate, hydroxyethyl (meth)acrylate, and hydroxypropyl (meth)acrylate; acrylamide or substituted acryl amides; styrene or substituted styrenes; butadiene; ethylene; vinyl acetate or other vinyl esters such as vinyl acetate, vinyl propionate, vinyl butyrate and vinyl laurate; vinyl ketones, including vinyl methyl ketone, vinyl ethyl ketone, vinyl isopropyl ketone, and methyl isopropenyl ketone; vinyl ethers, including vinyl methyl ether, vinyl ethyl ether, vinyl propyl ether, and vinyl isobutyl ether; vinyl monomers, such as, for example, vinyl chloride, vinylidene chloride, N-vinyl pyrrolidone; amino monomers, such as, for example, N,N′-dimethylamino (meth)acrylate; and acrylonitrile or methacrylonitrile; and the monomethacrylates of dialkylene glycols and polyalkylene glycols. Descriptions for making porous and macroreticular polymers can be found in U.S. Pat. No. 7,422,879 (Gebhard et al.) and U.S. Pat. No. 7,098,252 (Jiang et al.).

The organic polymeric carriers can contain other organic polymeric particles and/or other inorganic carrier particles, such as minerals typically characterized as platy materials. Minerals suitable for incorporation into a polymeric carrier include, but are not limited to fumed and other forms of silicon including precipitated silicon and vapor deposited silicon; clay; kaolin; perlite bentonite; talc; mica; calcium carbonate; titanium dioxide; zinc oxide; iron oxide; silicon dioxide; and the like. Mixtures of different carriers can also be utilized.

### Selection of Components:

The choice of polymer(s) is generally made to provide an article having necessary and desired properties and a cost consistent with its use. The organic polymeric carriers are typically selected based on their porosity, surface area, and their ability to load sufficient biocide, and ultimate impact on the composition's properties. Porosity and surface area determine how much biocide can be loaded onto the organic polymeric carrier and generally reduces the amount of organic polymeric carrier required. The selection of biocide primarily depends on the use of the polymer/biocide combination. For example, the biocide loading can be tailored to target specific microorganisms or specific combinations of microorganisms, depending on the material's end use. Combinations of biocides can be utilized including both heat stabile and heat labile biocides in order to fulfill specific needs. In addition, combinations of biocides including bactericides, viruscides, fungicides, insecticides, acaricides, molluscicides, herbicides, miticides, rodenticides, animal and insect repellants, and the like can be incorporated into a single polymer, depending on it end use. Additionally, incompatible materials, whether heat labile or not, can be loaded into separate carriers and incorporated into polymers.

Heat labile components can be loaded onto the carrier in any order. Combinations of heat labile components can be loaded onto a single carrier, or loaded onto individual carriers, depending on compatibility issues, and other factors. In addition, the amounts of heat labile biocides can be adjusted to accomplish a particular result. For example, with regard to biocides, different results can be achieved by modifying the quantities of one or more components, by eliminating components, and by adding new components. In other words, the surface's resulting properties can be adjusted to suit its particular needs by selecting specific components and the amounts of each component. More recent work has shown that increased efficacy can be achieved by milling the loaded carrier particles to a particle size in the order of about 1 micron, before the combination's inclusion into a polymer.

### The Process:

The carrier/biocide combination has been produced by contacting a carrier with a liquid form of the biocide (typically a solution or a suspension), allowing adsorption onto the organic polymeric carrier to occur and evaporating any solvent to provide the carrier/biocide combination in the form of a flow-able powder. Carrier loaded biocides containing as much as 60% biocides have been prepared. Multiple biocides can be loaded onto a single carrier, provided the multiple biocides are not incompatible. However, the utilization of a single biocide/single carrier combination avoids the issue of biocide incompatibility and offers advantages regarding flexibility with regard to the variety of available formulations.

The carrier/biocide combination has also been produced by encapsulating the carrier/biocide combination after and/or during the loading process. The encapsulation process can occur in parallel with separate carrier/biocide combinations that can then be combined and further encapsulated or the encapsulation process can be carried out sequentially. Parallel encapsulations have generally provided superior results when working with otherwise incompatible biocides. Generally the encapsulating agent is determined based on the carrier/biocide combination selected. For carriers involving SiO₂, TiO₂, and ZnO₂, N,N-Bis(3-aminopropyl)dodecylamine has been utilized as an encapsulating agent. The addition of Diisobutylphenoxyethoxyethyldimethylbenzyl ammonium chloride monohydrate and Ion Pure (silver iodide coated onto glass beads available from Mitushita Glass) provides a biocidal effect and additionally assists in maintaining gasses and volatiles within the encapsulated carrier/biocide combination. The carrier/biocide combination can be constructed with a single encapsulation process, a double encapsulation process or can involve any number of encapsulations, depending on the desired properties and the number of components. Example 8 illustrates the encapsulation method described above.

To develop a method, a processing temperature is established for the polymer/carrier/biocide combination (or combination containing another heat labile component) and a maximum processing time at the processing temperature is established, before the processing is carried out. Processing equipment is selected to minimize melt time for the polymer/carrier/biocide combination. Conventional equipment for processing polymers can generally be used. Based on current work, single or twin thermal screws are effective for producing both masterbatch material and finished articles. Standard pellet extrusion has proven a useful method for producing masterbatch materials. Finished articles or intermediate forms of the polymer can be prepared by the following techniques: injection molding, roll molding, rotational molding, extrusion, casting, and the like. Organic polymeric carrier/biocide loading into the polymer melt can run at least as high as about 40 wt. % carrier/biocide. For masterbatch materials, the carrier/biocide concentration also typically runs as high as about 40 wt. %. Masterbatch materials are polymer/carrier/biocide combinations containing a high level of carrier/biocide for subsequent incorporation into a final polymer product through a subsequent processing step. Although masterbatch materials can take a variety of forms, they are typically provided in pellet form, and standard pellet extrusion has proven a useful method for producing masterbatch materials. As noted above, however, masterbach materials can also involve a liquid form including the carrier/heat labile component. For finished articles or intermediate forms, biocide levels in the range of about 0.25 wt. % to 10 wt. % have proven effective against microorganism's tested. However, even higher loadings are contemplated and will be effective.

### Applications Utilizing Biocidal Polymers:

Applications involving the polymer/biocide combination taught herein include, but are not limited to a wide range of materials which can be used to form surfaces and equipment utilized in the medical and consumer fields including hospital, emergency treatment, first aid, and the like. Any product that is or could be prepared from a polymer melt or other fluid that otherwise requires processing at an elevated temperature and which would benefit from the ability to contain a heat labile component such as a biocide to limit the growth of microorganisms can be improved by utilizing the polymer/biocide combinations taught herein. Some specific examples of articles include, but are not limited to things we touch such as: counter tops, furniture components (e.g. a bed rail, a toilet seat, a shower stall, a sink, etc.), equipment (e.g. a bed pan, a door handle, shopping cart handles, a writing instrument, a computer keyboard, a telephone, toothbrush components, dental equipment, etc.), surgical equipment (e.g. clamps, surgeon's gloves, etc.), wound and hygiene products (e.g. bandages), and clothing (e.g. doctor's gown, patient's gown, nurses outer clothing, bedding, etc.). In addition, air filters constructed from porous forms of the polymer/biocide combination can minimize the microorganism content of the air circulating within a hospital, an office building, a hotel, a home, or other structure with central air handling equipment. Breathing masks and related portable air-filtering systems can similarly benefit from the use of filters constructed from the polymer/biocide combinations. In addition, filters suitable for handling other fluids such as liquids can similarly be passed through filters constructed from the polymer/biocide combination to cause reduction in the microorganism content of the fluid being treated. Finally, clothing constructed from fabrics prepared from the polymer/biocide combination can provide additional protection for individuals exposed to a range of biological hazards or weapons. Many of the articles above are also important components in schools, where colds, influenza, and the like typically spread quickly through surface contacts and air-born microorganisms. Polymers containing insecticides can be utilized to prepare articles such as siding, molding such as baseboards, carpeting, and the like to allow the killing of susceptible insects that contact the polymer/insecticide material. Fabrics including insecticides/miticides can be provided and incorporated into bedding supplies to control the reproduction and spread of organisms such as bed bugs and the like.

Finally, the present disclosure provides for polymeric materials utilizing the carrier technology which can contain components selected from the group consisting of bactericides, fungicides, insecticides, acaracides, molluscicidies, rodenticides, volatile fragrances (including animal and insect repellants), and the like. Such polymeric materials are particularly suitable for forming a variety of building materials, and for manufacturing garbage cans/bags and other equipment designed to handle garbage, food wastes, and the like. Articles manufactured from this polymeric material can mask odors, minimize bacterial and fungal growth, retard the proliferation of flies and other harmful insects, and prevent the proliferation of rodents. The incorporation of animal repellants in polymeric materials utilized for garbage handling equipment/articles handling food products can also keep pets and wild animals away. This is particularly desirable for garbage cans/bags awaiting pickup in unattended locations. Articles manufactured from polymeric materials containing combinations of these components can ultimately be recycled without leaching substantial amounts of biocides/pesticides into the environment.

### SPECIFIC EXAMPLES

### Example 1

### Preparation of Silica loaded with N,N-didecyl-N-methyl-N-(3-trimethoxysilylpropyl)ammonium chloride

Eighty-three parts by weight of a methanolic solution containing 72% N,N-didecyl-N-methyl-N-(3-trimethoxysilylpropyl)ammonium chloride was combined with 40 parts by weight of fumed silica (SiO₂). The moist combination was mixed for about 5 minutes at ambient temperature in a high speed mixer at approximately 1200 rpm to provide a flowable powder. More dilute solutions of the biocide produces a wet paste, rather than a flowable powder. The resulting methanol wet carrier/quaternary salt can be incorporated into a polymer directly or dried before further use.

This method was used to prepare carrier/biocide combinations utilizing silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride. Additionally, the method described above can also be utilized to prepare other carrier/biocide combinations utilizing the carriers including clay; kaolin; perlite bentonite; talc; mica; calcium carbonate; titanium dioxide; zinc oxide; and iron oxide.

Although multiple compatible biocides can be loaded into a single carrier, loading a single biocide into a single carrier is preferred when a combination of biocides utilized are incompatible. The single biocide/single carrier loading also allows greater flexibility in formulating a variety of biocide/polymer combinations. Multiple biocide/carrier combinations can be added to a single polymer at the masterbatch stage or when incorporated into a polymer product.

### Example 2

### Preparation of Polymer loaded with N,N-didecyl-N-methyl-N-(3-trimethoxysilylpropyl)ammonium chloride

(a) Polymer selection and pretreatment: A commercial grade of the macroreticular crosslinked styrene/divinylbenzene resin, XAD™ 16, available from Rohm and Haas can be obtained, rinsed with water, dried, and ground to provide particles ranging from about 1 to about 100 nm. XAD is a common law trademark belonging to Rohm & Haas Company 100 Independence Mall West, Philadelphia, Pa. 19106-2399.

(b) Polymer Loading: 83 parts by weight of a methanolic solution containing 72% N,N-didecyl-N-methyl-N-(3-trimethoxysilylpropyl)ammonium chloride are combined with 25 parts by weight of the XAD™ 16 polymer pre-treated as described above. The moist combination is mixed for about 5 minutes at ambient temperature in a high speed mixer at approximately 1200 rpm to provide a flow able powder. More dilute solutions of the biocide produces a wet paste, rather than a flow able powder. The resulting methanol wet carrier/quaternary salt can be incorporated into a polymer directly or dried before further use.

This method can be used to prepare organic polymeric carrier/biocide combinations utilizing an organic polymeric carrier and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, and N-didecyl-N-dimethyl-ammonium chloride. Other suitable organic polymeric carriers can include resins, particularly macroreticular resins derived from styrene, acrylic acid, alkylacrylates, acrylamides, phenol/formaldehyde combinations, vinylpyridines, vinylimidazoles, combinations thereof, and the like. Gel and macroreticular resins can be unsubstituted or substituted. Polymers having lower levels of cross-linking will typically swell more during loading and are expected to provide greater carrier capacities than more heavily crosslinked resins. Preferred macroreticular resins have a surface area of at least about 50 m²/gm, more preferred resins have a surface area of at least about 200 m²/gm, and most preferred resins have a surface area of at least about 500 m²/gm. Commercially available macroreticular resins which can serve as carrier particles include, but are not limited to the resins, XAD™ 2, XAD™ 4, XAD™ 7, XAD™ 16, XAD™ 200, XAD™ 761, XAD™ 1180, and XAD™ 2010.

Although multiple compatible biocides can be loaded into a single carrier, loading a single biocide into a single carrier is preferred when a combination of biocides utilized are incompatible. The single biocide/single carrier loading also allows greater flexibility in formulating a variety of biocide/polymer combinations. Multiple biocide/carrier combinations can be added to a single polymer at the masterbatch stage or when incorporated into a polymer product.

### Example 3

### Preparation of Carrier/Polymer Masterbatch Pellets

A heated single thermal screw equipped with a port for addition of the carrier and a port for removal of methanol vapor was prepared for the thermal extrusion of polystyrene. Once molten polystyrene was moving through the extruder, the carrier/quat combination prepared above was added to the extruder at a rate to provide a polymer: (carrier/biocide) ratio of 60:40, by weight. Excess methanol and other volatiles were vented from the venting port. The extruder was operated to provide a polymer residence time within the extruder of about 1-2 minutes. The hot polymer was extruded into water to produce a pencil shaped extrusion product that was subsequently cut into pellets. The resulting wet pellets were separated from the water, dried, and sized for subsequent incorporation into polymer articles. Similar masterbatch pellets were prepared according to this procedure incorporating the carrier/biocide combinations including silica and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, or N-didecyl-N-dimethyl-ammonium chloride.

### Example 4

### Preparation of Organic Polymeric Carrier/Polymer Masterbatch Pellets

A heated single thermal screw equipped with a port for addition of the carrier and a port for removal of methanol vapor is prepared for the thermal extrusion of polystyrene. Once molten polystyrene is moving through the extruder, the carrier/quat combination prepared above is added to the extruder at a rate to provide a polymer: (carrier/biocide) ratio of about 60:40, by weight. Excess methanol and other volatiles are vented from the venting port. The extruder is operated to provide a polymer residence time within the extruder of about 1-2 minutes. The hot polymer is extruded into water to produce a pencil shaped extrusion product that is subsequently cut into pellets. The resulting wet pellets are separated from the water, dried, and sized for subsequent incorporation into polymer articles. Similar masterbatch pellets can be prepared according to this procedure incorporating the carrier/biocide combinations including a crosslinked macroreticular resin and, cetyl pyridinium chloride, N,N-bis(3-aminopropyl)dodecylamine, N-octyl-N-decyl-N-dimethyl-ammonium chloride, N-di-octadecyl-N-dimethyl-ammonium chloride, or N-didecyl-N-dimethyl-ammonium chloride.

This procedure can also used to prepare similar masterbatch pellets utilizing polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. Masterbatch pellets can similarly be made using a combination or blend of polymers.

For polymers that have high melt viscosities, a thermal screw extruder having good mixing is important in order to ensure the complete distribution of the carrier/biocide throughout the entire melt.

### Example 5

### Preparation of Articles from Masterbatch Pellets

A single screw heated extruder of the type described above for preparing the master batch material (prepared either in Example 1 or 2) is used to extrude a sheet form of the polymer. As in the method for preparing a master batch material, polystyrene is introduced into the extruder to provide a melt by the time material reached the addition port. The master batch material prepared above is added through the addition port to provide a ratio of biocide/polymer of about 0.25 wt. % to 10 wt. %. Residence time within the extruder is controlled between 1 and 2 minutes to provide polystyrene in a sheet form. Using the same equipment, and masterbatch pellets incorporating the other polymers listed or blends thereof, this procedure can be used to prepare sheet forms of polyvinylchloride, thermoplastic elastomers, polyurethanes, high density polyethylene, low density polyethylene, silicone polymers, fluorinated polyvinylchloride, styrene-acrylonitrile resin, polyethylene terephthalate, rayon, styrene ethylene butadiene styrene rubber, cellulose acetate butyrate, polyoxymethylene acetyl polymer, latex polymers, natural and synthetic rubbers, epoxide polymers (including powder coats), and polyamide6. All of the polymers are able to pass through the processing without color formation or other visible signs of biocide degradation. Depending on the polymer selected, residence times as long as 30 minutes can be utilized without decomposition of the biocide. Finally, the carrier/biocide combination formed in Example 1 can also be utilized directly with an appropriate dilution to prepare polymer loaded with biocide without utilizing the polymer masterbatch pellet material.

### Example 6

### Preparation of Polymer Loaded with an Antibiotic

About 80 parts of a methanolic suspension containing about 70% wt. % penicillin is combined with about 40 parts of the macroreticular polymer processed as described in Example 1 (a), above. The moist combination is mixed for about 5 minutes at ambient temperature in a high speed mixer at approximately 1200 rpm to provide a flow able powder. The resulting methanol wet carrier/antibiotic salt can be incorporated into a polymer directly or dried before further use.

This method can be used to prepare further carrier/antibiotic combinations utilizing silica and, amoxicillin, campicillin, piperacillin, carbenicillin indanyl, methacillin cephalosporin cefaclor, streptomycin, tetracycline and the like. Additionally, the method described above can also be utilized to prepare other carrier/biocide combinations involving other macroreticular resins derived monomers such as styrene, acrylic acid, alkylacrylates, acrylamides, phenol/formaldehyde combinations, vinylpyridines, vinylimidazoles, combinations thereof, and the like.

### Example 7

### The Incorporation of a Carrier/Antibiotic Combination into a Polymer Masterbatch and Polymer Article

The procedure described in Example 2 can be utilized to prepare antibiotic loaded polymer masterbatch pellets and the procedure described in Example 3 can be utilized to prepare antibiotic loaded polymer articles from the masterbatch pellets containing an antibiotic. Finally, the carrier/antibiotic combination can also be utilized directly with an appropriate dilution to prepare polymer loaded with antibiotic without utilizing the polymer masterbatch pellet material.

### Example 8

### Biological Tests

ASTM E 2180, the standard method for determining the activity of incorporated antimicrobial agents in polymers or hydrophobic material, is utilized to test untreated sheets of polypropylene and sheets of polypropylene containing 1% N,N-didecyl-N-methyl-N-(3-trimethoxysilylpropyl)ammonium chloride prepared according to the procedure described in Example 3 above. The samples are tested by pipetting a thin layer of inoculated agar slurry [Klebsiella Pneumoniae ATCC#4352, and Staphylococcus aureus ATCC#6538] onto the untreated sheets and onto the treated sheets. Testing is carried out in triplicate. After 24 hours of contact at 35° C., surviving microorganisms are recovered into neutralizing broth. Serial dilutions are made, and bacterial colonies from each dilution series are counted and recorded. Percent reduction of bacteria from treated versus untreated samples are calculated.

The geometric mean of the number of organism recovered from the triplicate incubation period control and incubation period treated samples are calculated and the percent reduction was determined by the following formula:

$$\% reduction = \frac{a - b}{a} \times 100$$

where a=the antilog geometric mean of the number of organisms recovered from the incubation period control sample; and

b=the geometric mean of he number of organisms recovered from the incubation period treated samples.

Substantial reduction in the level of bacterial growth is obtained for regions in contact with the sheets containing the carrier/biocide combination.

The heat labile biocides described above can be similarly incorporated into the polymers described herein to provide polymer/biocide combinations which are capable of retarding the growth of microorganisms including, but not limited to E. coli, MRSA, Clostridium difficile, Aspergillus niger, and H1N1 Influenza A virus.

### Example 9

### Preparation of Biopolymer

(a) Preparation of the Carrier Package

250 grams of SiO2, 200 grams, 200 grams of an solution of N Bis(3-aminopropyl) dodecylamine chloride (as a 60% N,N Bis(3-aminopropyl) dodecylamine chloride) and 40 grams of fumed silica (SiO₂) were combined and mixed in a high speed mixer (about 1200 rpm) for about 2 minutes at ambient temperature to provide a flowable powder. Sufficient amounts of additional dilute solutions of the N-Bis(3-aminopropyl)dodecylamine chloride were added to convert the flowable powder into a wet paste. The following components were added to the wet paste: 20 grams TiO2, 20 grams of Ion pure (silver iodide coated onto 5-10 micron glass beads), 30 grams of DIISOBULYLPHENOXYETHOXY ETHYL DIMETHYL BENZYL AMMONIUM CHLORIDE MONOHYDRATE, and 200 grams of aqueous N,N Bis(3-aminopropyl) dodecylamine chloride. The combination was compounded for about 2 minutes at ambient temperature at a low mix rate less than 1200 rpm to mix the moist paste and the resulting paste was compressed in a high speed shaker to remove any entrained air.

Additional components, 4.2 grams of N-ALKYL (C14-50%, C12-40%, C16-10%), 0.5 grams of SiO₂ and 0.5 grams of TiO₂ were incorporated into the thick paste as described above. Sufficient N,N-Bis(3-aminopropyl)dodecylamine chloride was added to maintain the material in the form of a thick paste that was thoroughly mixed. This process was repeated sequentially with the addition of biocides 3-29.

The following biocides were all included into the carrier package sequentially as described above:
(1) N,N-Bis(3-aminopropyl) dodecylamine chloride,
(2) N-ALKYL (C14-50%, C12-40%, C16-10%)
(3) DIMETHYL BENZYL AMMONIUM CHLORIDE,
(3) 1,3-BIS(HYDROXYMETHYL)-5,
(4) 5-DIMETHYLHYDANTOIN, 1-(HYDROXYMETHYL)-5,5-DIMETHYLHYDANTOIN,
(6) 3-IODO-2-PROPYNYL BUTYL CARBAMATE,
(7) DIDECYL DIMETHYL AMMONIUM CHLORIDE,
(8) N-ALKYL (C14-50%, C12-40%, C16-10%) DIMETHYL BENZYL AMMONIUM CHLORIDE,
(9) 1,3-DI-(HYDROXYMETHYL)-5,5-DIMETHYLHYDANTOIN,
(10) 3-(HYDROXYMETHYL)-5,5-DIMETHYLHYDANTOIN, 5,5-DIMETHYLHYDANTOIN,
(11) 5-CHLORO-2-METHYL-4-ISOTHIAZOLIN-3-ONE,
(12) 2-METHYL-4-ISOTHIAZOLIN-3-ONE,
(13) N-ALKYL (C14-60%, C16.30%, C12-50%, C18-5%) DIMETHYL BENZYL AMMONIUM CHLORIDE,
(14) N-ALKYL (C12-50%, C14-30%, C16-17%, C18.3%) DIMETHYL BENZYL AMMONIUM CHLORIDE, DIOCTYL DIMETHYL AMMONIUM CHLORIDE, DIDECYL DIMETHYL AMMONIUM CHLORIDE,
(15) N,N-DIDECYL-N,N-DIMETHYLAMMONIUM CHLORIDE,
(16) ETHANE-1,2-DIOL, N,N BIS (3-AMINOPROPYL) DODECYLAMINE,
(17) DIMETHYL BENZYL AMMONIUM CHLORIDE,
(18) OCTYL DECYL DIMETHYL AMMONIUM CHLORIDE,
(19) DIOCTYL DIMETHYL AMMONIUM CHLORIDE,
(20) 1-BROMO-3-CHLORO-5,5-DIMETHYLHYDANTOIN,
(21) 3-BROMO-1-CHLORO-5,5-DIMETHYLHYDANTOIN,
(22) 1,3-DIBROMO-5,5-DIMETHYLHYDANTOIN,
(23) BORIC ACID
(24) N-TRICHLOROMETHYLTHIO-4-CYCLOHEXENE-1,2-DICARBOXIMIDE,
(25) N-(TRICHLOROMETHYLIO) PHTHAALIMIDE, CARBAMIC ACID
(26) BUTYL-,3-IODO-2-PROPYNYLESTER 55406-53-6,
(27) 3-IODO-2-PROPYNL BUTYL CARBAMATE,
(28) 3-IODO-2-PROPYNL BUTYL CARBAMATE,
(29) (TETRACHOROISOPHTHALONITRILE)

### Sample Preparation:

The general procedure described in Examples 3 and 4 was repeated to provide polypropylene samples plates for testing. A heated single thermal screw equipped with a port for addition of the carrier and an exhaust port for pressure relief was utilized. Once molten polypropylene was moving through the extruder, the carrier package prepared above was added to the extruder at a rate to provide a polymer/carrier package ratio of 60:40, by weight. The extruder was operated to provide a polymer residence time within the extruder of about 1-2 minutes. The molten polymer was extruded to produce solid in the form of plates for testing. Pencil shaped extrusion product was also produced by this method that was subsequently cooled and solidified in water and cut into pellets. The resulting wet pellets were separated from the water, dried, and sized for subsequent incorporation into polymer articles.

### Testing of Biopolymer:

The Biopolymer was prepared according to the procedure described above and was evaluated according to the standard testing method (JIS Z 2801) developed for determining the ability of plastics and other antimicrobial surfaces to inhibit the growth of microorganisms or kill them, over a designated period of contact.

### An Overview of the JIS Z 2801 Test:

A test microorganism is prepared, typically by growth in a liquid culture medium. A suspension of test microorganism is standardized by dilution in a nutritive broth (affording microorganisms the potential to grow during the test). Both control and test surfaces are inoculated with microorganisms, typically in triplicate, and then the microbial inoculum is covered with a thin, sterile film or similar cover. By covering the inoculum it is spread, evaporation is prevented, and close contact with the antimicrobial surface is assured. Microbial concentrations are initially determined at “time zero” by elution followed by dilution and plating.

Inoculated, covered control and antimicrobial test surfaces are allowed to incubate undisturbed in a humid environment for the test period, often 24 hours. Following incubation, microbial concentrations are determined. Calculations are carried out to determine the reduction of microorganisms relative to initial concentrations and the control surface.

### Surface Testing:

The JISZ 2801 Test Method was utilized to test plates of the polymer/carrier/biocides prepared in above and appropriately designated. Tests conducted according to the JISZ 2801 method involved: Influenza A (H1N1) virus (ATCC VR-1469); Poliovirus type 1 (ATCC VR-1562); Vancomycin Resistant Enterococcus faecalis-VRE (ATCC 51575); Pseudomonas aeruginosa (ATCC 15442); Acinetobacter baumannii (ATCC 19606); Clostridium difficile-spore form (ATCC 43598); Methicillin Resistant Staphylococcus aureus-MRSA (ATCC 33592); and Aspergillus niger (ATCC 6275). The results are provided below:

### Antiviral Studies:

The following data analysis was utilized in evaluating the effectiveness of the Biopolymer samples against viral strains.

### Calculation of Titers

Viral and cytotoxicity titers will be expressed as −log₁₀ of the 50 percent titration endpoint for infectivity (TCID₅₀) or cytotoxicity (TCD₅₀), respectively, as calculated by the method of Spearman Karber.

$$\begin{matrix}Log of 1 st dilution inoculated - [ ( ( \frac{Sum of \% mortality at each dilution}{100} ) - 0.5 ) \times ( logarithm of dilution ) ] & \\ Geometric Mean = Antilog of \text{:} & \\ \frac{{Log}_{10} {X}_{1} + {Log}_{10} {X}_{2} + {Log}_{10} {X}_{3}}{{3}^{*}} & \\ \begin{matrix}( X equals {TCID}_{50} / 0.1 mL of each test or control replicate ) \\ {}^{*} This value ( or number of values for X ) may be \\ adjusted depending on the number of replicates requested .\end{matrix} & \end{matrix}$$

### Calculation of Log Reduction

Zero Time Virus Control TCID₅₀−Test Substance TCID₅₀=Log Reduction and/or

Virus Control TCID₅₀−Test Substance TCID₅₀=Log Reduction

### Calculation of Percent Reduction

$$\% Reduction = 1 - [ \frac{{TCID}_{50} test}{{TCID}_{50} zero time virus control} ] \times 100$$

$$and \text{/} or$$

$$\% Reduction = 1 - [ \frac{{TCID}_{50} test}{{TCID}_{50} virus control} ] \times 100$$

### Anti-Viral Test Results

A) Influenza A (H1N1) virus (ATCC VR-1469)

Under the conditions of this investigation and in the presence of a 1% fetal bovine serum organic soil load, the Biopolymer, (treated FDA grade plastic), demonstrated complete inactivation of Influenza A (H1N1) virus following a 2 hour exposure time at room temperature (20.0° C.) in a relative humidity of 50%.

The titer of the input virus control (starting titer of the virus) was 7.00 log₁₀. The virus recovered from the untreated FDA grade plastic following the 2 hour exposure time (2 hour virus control) was 7.00 log₁₀, indicating that virus was not lost during the 2 hour exposure time.

### Mean Reduction

The Biopolymer demonstrated a ≧99.993% mean reduction in viral titer, as compared to the titer of the virus control held for the 2 hour exposure time.

The mean log reduction in viral titer was ≧4.17 log₁₀, as compared to the titer of the virus control held for the 2 hour exposure time.

### Individual Reduction

Replicate #1 and #3 demonstrated a ≧99.997% reduction in viral titer, as compared to the titer of the virus control held for the 2 hour exposure time.

The log reduction in viral titer was ≧4.50 logᵢₙ, as compared to the titer of the virus control held for the 2 hour exposure time.

Replicate #2 demonstrated a ≧99.97% reduction in viral titer, as compared to the titer of the virus control held for the 2 hour exposure time.

The log reduction in viral titer was ≧3.50 logᵢₙ, as compared to the titer of the virus control held for the 2 hour exposure time.

### B) Poliovirus Type 1 (ATCC VR-1562)

Results of tests with two samples of the Biopolymer, treated FDA grade plastic, exposed to Poliovirus type 1 in the presence of a 1% fetal bovine serum organic soil load at room temperature (20.0° C.) in a relative humidity of 50% for two and five minute exposure times. All cell controls were negative for test virus infectivity. The titer of the input virus control was 8.00 logᵢₙ. The titer of the zero time virus control (untreated FDA grade plastic) was 7.50 logᵢₙ. The titer of the virus controls (untreated FDA grade plastic) was 7.50 log₁₀ for the 2 minute exposure time and 8.25 log₁₀ for the 5 minute exposure time.

Following the 2 minute exposure time, test virus infectivity was detected at 6.50 log₁₀. Following the 5 minute exposure time, test virus infectivity was detected at 7.25 logᵢₙ. Test substance cytotoxicity was observed in the cytotoxicity control at 1.50 logᵢₙ. The neutralization control (non-virucidal level of the test substance) indicates that the test substance was neutralized at ≦1.50 log₁₀.

Under the conditions of this investigation and in the presence of a 1% fetal bovine serum organic soil load, the Bipolymer, treated FDA grade plastic, demonstrated a 90.0% reduction in viral titer following a 2 minute exposure time at room temperature (20.0° C.) in a relative humidity of 50% to Poliovirus type 1, as compared to the titer of the virus control held for the 2 minute exposure time. The log reduction in viral titer was 1.00 logᵢₙ, as compared to the titer of the virus control held for the 2 minute exposure time.

Under the conditions of this investigation and in the presence of a 1% fetal bovine serum organic soil load, the Biopolymer, treated FDA grade plastic, demonstrated a 90.0% reduction in viral titer following a 5 minute exposure time at room temperature (20.0° C.) in a relative humidity of 50% to Poliovirus type 1, as compared to the titer of the virus control held for the 5 minute exposure time. The log reduction in viral titer was 1.00 log₁₀, as compared to the titer of the virus control held for the 5 minute exposure time

### Antibacterial Studies:

The following general protocol for data analysis was utilized in evaluating the effectiveness of the Biopolymer samples against bacterial strains.

### Number of Organisms Present on Carriers

$$CFU \text{/} carrier = \frac{\begin{matrix}( average CFU at a given dilution ) \times ( dilution factor ) \times \\ ( volume of neutralizer in mL )\end{matrix}}{( volume plated in mL )}$$

### Geometric Mean of Number of Organisms Surviving on the Test or Untreated Carriers

$$Geometric Mean = Antilog of \frac{{Log}_{10} {X}_{1} + {Log}_{10} {X}_{2} + … {Log}_{10} {X}_{N}}{N}$$

Where: X equals CFU/carrier
   N equals number of control carriers

### Percent Reduction per Time Point Evaluated

% reduction=[(a−b)/a]×100
a=Geometric mean of the number of organisms surviving on the untreated carriers* at specified exposure time
b=Geometric mean of the number of organisms surviving on the test carriers at specified exposure time

### Log₁₀ Reduction Per Time Point Evaluated

Average Log₁₀(CFU/untreated carrier*)−Average Log₁₀(CFU/test carrier)

*Note: Test reductions were determined based on the side-by-side provided untreated control results. However, if the untreated material was not available or if the organism did not survive on the untreated carriers, the test percent and log reduction calculations may be calculated using:
the T₀ control results which offer a test reduction over time, not taking into consideration natural organism die-off.
the stainless steel control results which offer organism reductions in the test as compared to survival on a hard, non-porous surface.

### Log₁₀ Difference for the Neutralization Confirmation Control

Recovery Log Difference=(Log₁₀NC Numbers Control)−(Log₁₀NC Test Results)

### Anti-Bacterial Test Results

C) Vancomycin Resistant Enterococcus faecalis-VRE (ATCC 51575)

The Bipolymer, demonstrated a >99.99% (>4.42 Log₁₀) reduction of Vancomycin Resistant Enterococcus faecalis-VRE (ATCC 51575) following a 5 minute exposure time as compared to an untreated control material (FDA/Poly Pro) when tested in the presence of a 5% fetal bovine serum organic soil load at 35-37° C. with ≧90% relative humidity.

The Biopolymer platform, demonstrated a >99.99% (>4.58 Log₁₀) reduction of Vancomycin Resistant Enterococcus faecalis-VRE (ATCC 51575) following a 1 hour exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer platform demonstrated a >99.99% (>4.42 Log₁₀) reduction of Vancomycin Resistant Enterococcus faecalis-VRE (ATCC 51575) following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer platform demonstrated a >99.99% (>4.58 Log₁₀) reduction of Vancomycin Resistant Enterococcus faecalis-VRE (ATCC 51575) following a 1 hour exposure time as compared to the untreated control material (FDA/Poly Pro) when tested in the presence of a 5% fetal bovine serum organic soil load at 35-37° C. with ≧90% relative humidity.

D) Pseudomonas aeruginosa (ATCC 15442)

The Biopolymer demonstrated a >99.99% (>4.82 Log₁₀) reduction of Pseudomonas aeruginosa (ATCC 15442) following a 5 minute exposure time as compared to the untreated control material (FDA/Poly Pro) when tested in the presence of a 5% fetal bovine serum organic soil load at 35-37° C. with ≧90% relative humidity.

The Biopolymer demonstrated a >99.99% (>4.63 Log₁₀) reduction of Pseudomonas aeruginosa (ATCC 15442) following a 1 hour exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer demonstrated a >99.99% (>4.82 Log₁₀) reduction of Pseudomonas aeruginosa (ATCC 15442) following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer demonstrated a >99.99% (>4.63 Log₁₀) reduction of Pseudomonas aeruginosa (ATCC 15442) following a 1 hour exposure time as compared to the untreated control material (FDA/Poly Pro) when tested in the presence of a 5% fetal bovine serum organic soil load at 35-37° C. with ≧90% relative humidity.

E) Acinetobacter baumannii (ATCC 19606)

The Biopolymer demonstrated a >99.99% (>4.34 Log₁₀) reduction of Acinetobacter baumannii (ATCC 19606) following a 5 minute exposure time as compared to the untreated control material (FDA/Poly Pro) when tested in the presence of a 5% fetal bovine serum organic soil load at 35-37° C. with ≧90% relative humidity.

The Biopolymer demonstrated a >99.99% (>4.60 Log₁₀) reduction of Acinetobacter baumannii (ATCC 19606) following a 1 hour exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer demonstrated a >99.99% (>4.34 Log₁₀) reduction of Acinetobacter baumannii following a 5 minute exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer demonstrated a >99.99% (>4.60 Log₁₀) reduction of Acinetobacter baumannii following a 1 hour exposure time as compared to the untreated control material (FDA/Poly Pro) when tested in the presence of a 5% fetal bovine serum organic soil load at 35-37° C. with ≧90% relative humidity.

F) Clostridium difficile-Spore Form (ATCC 43598)

The Biopolymer, demonstrated a <79.7% (<0.69 Log₁₀) reduction of Clostridium difficile-spore form (ATCC 43598) following a 2 hour exposure time as compared to the untreated control material (FDA/Poly Pro) when tested in the presence of a 5% fetal bovine serum organic soil load at 35-37° C. with ≧90% relative humidity.

Under the conditions of this investigation, the Biopolymer demonstrated a <79.7% (<0.69 Log₁₀) reduction of Clostridium difficile-spore form following a 2 hour exposure time as compared to the untreated control material (FDA/Poly Pro) when tested in the presence of a 5% fetal bovine serum organic soil load at 35-37° C. with ≧90% relative humidity.

G) Methicillin Resistant Staphylococcus aureus-MRSA (ATCC 33592)

The Biopolymer demonstrated a >99.99% (>4.44 Log₁₀) reduction of Methicillin Resistant Staphylococcus aureus-MRSA (ATCC 33592) following a 55 second exposure time as compared to the untreated control material (FDA/Poly Pro) when tested in the presence of a 5% fetal bovine serum organic soil load at 35-37° C. with ≧85% relative humidity.

The Biopolymer demonstrated a >99.99% (>4.57 Log₁₀) reduction of Methicillin Resistant Staphylococcus aureus-MRSA (ATCC 33592) following a 2 minute exposure time as compared to the untreated control material (FDA/Poly Pro) when tested in the presence of a 5% fetal bovine serum organic soil load at 35-37° C. with ≧88% relative humidity.

The Biopolymer demonstrated a >99.99% (>4.54 Log₁₀) reduction of Methicillin Resistant Staphylococcus aureus-MRSA (ATCC 33592) following a 1 hour exposure time as compared to the untreated control material (FDA/Poly Pro) when tested in the presence of a 5% fetal bovine serum organic soil load at 35-37° C. with ≧90% relative humidity.

### Anti-Fungal Test Results

H) Aspergillus niger (ATCC 6275)

The following protocol for data analysis described above for the bacterial studies was utilized in evaluating the effectiveness of the Biopolymer samples against this fungal strain.

The Biopolymer demonstrated no reduction of Aspergillus niger (ATCC 6275) following a 5 minute exposure time as compared to the untreated control material (FDA/Poly Pro) when tested in the presence of a 5% fetal bovine serum organic soil load at 35-37° C. with ≧90% relative humidity.

The Biopolymer demonstrated a 64.5% (0.45 Log₁₀) reduction of Aspergillus niger (ATCC 6275) following a 1 hour exposure time as compared to the untreated control material (FDA/Poly Pro) when tested in the presence of a 5% fetal bovine serum organic soil load at 35-37° C. with ≧90% relative humidity.

I) Trichophyton mentagrophytes (ATCC 9533)

The following protocol for data analysis described above for the bacterial studies was utilized in evaluating the effectiveness of Biopolymer samples against this fungal strain.

The Biopolymer demonstrated a 64.5% reduction (0.45 Log₁₀) reduction of Trichophyton mentagrophytes (ATCC 9533) following a 55 second exposure time as compared to the untreated control material (FDA/Poly Pro) when tested in the presence of a 5% fetal bovine serum organic soil load at 35-37° C. with ≧87.22% relative humidity.

The Biopolymer demonstrated a 94.5% (1.26 Log₁₀) reduction of Trichophyton mentagrophytes (ATCC 9533) following a 2 minute exposure time as compared to the untreated control material (FDA/Poly Pro) when tested in the presence of a 5% fetal bovine serum organic soil load at 35-37° C. with ≧87.22% relative humidity.

The Biopolymer demonstrated a >99.999% (>5.21 Log₁₀) reduction of Trichophyton mentagrophytes (ATCC 9533) following a 1 hour exposure time as compared to the untreated control material (FDA/Poly Pro) when tested in the presence of a 5% fetal bovine serum organic soil load at 35-37° C. with ≧90% relative humidity.

The present invention contemplates modifications as would occur to those skilled in the art. It is also contemplated that a variety of materials incapable of surviving intimate contact with a molten phase at elevated temperatures can survive such processing by first being incorporated into an appropriate carrier material as disclosed herein, and that such variation of the present disclosure might occur to those skilled in the art without departing from the spirit of the present invention. All publications cited in this specification are herein incorporated by reference as if each individual publication was specifically and individually indicated to be incorporated by reference and set forth in its entirety herein.

While the disclosure has been illustrated and described in detail in the figures and foregoing description, the same is to be considered as illustrative and not restrictive in character, it being understood that only selected embodiments have been shown and described and that all changes, modifications and equivalents that come within the spirit of the disclosures described heretofore and/or defined by the following claims are desired to be protected. In addition, all publications cited herein are indicative of the level of skill in the art and are hereby incorporated by reference in their entirety as if each had been individually incorporated by reference and fully set forth.

1. A surface comprising a polymer having a continuous solid phase, and a heat labile component/carrier combination therein, wherein:
(a) the polymer has a melting temperature;
(b) the heat labile component has a transformation temperature;
(c) the polymer's melting temperature is greater than the heat labile component's transformation temperature;
(d) the heat labile component/carrier combination is distributed throughout the polymer's continuous solid phase; and
(e) the surface exhibits at least one property derived from the heat labile component.

2. The surface of claim 1, wherein said surface is included in a member selected from the group consisting of structures, articles, containers, devices, woven/nonwoven articles, and remediation materials.

3. The surface of claim 1, wherein the heat labile component/carrier combination involves a carrier loaded with a heat labile component and the combination is encapsulated within the polymer's continuous phase.

4. The surface of claim 1, wherein the composition includes a plurality of heat labile component/carrier combinations.

5. The surface of claim 1, wherein the heat labile component is a heat labile biocide.

6. The surface of claim 5, wherein the heat labile biocide is selected from the group consisting of a bactericide, a fungicide, an algicide, a miticide, a viruscide, an insecticide, a herbicide, repellent, and combinations thereof.

7. The surface of claim 5, wherein the heat labile biocide is a quaternary amine derivative and the polymer's melting temperature is ≧180° C.

8. The surface of point 1, wherein the polymer is selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide.

9. The surface of point 1, wherein the heat labile component is a volatile component.

10. The surface of claim 2, wherein said surface is included in a structure.

11. The surface of claim 2, wherein said surface is included in an article.

12. The surface of claim 2, wherein said surface is included in a container.

13. The surface of claim 2, wherein said surface is included in a device.

14. The surface of claim 2, wherein said surface is included in a woven/nonwoven article.

15. The surface of claim 2, wherein said surface is included in a remediation material.

16. The surface of claim 1, wherein at least two incompatible heat labile components are distributed throughout the polymer's continuous solid phase.

17. A method for preparing a surface including a polymer, a heat labile component, and a carrier comprising:
(a) providing a mixture including a polymer and a heat labile component adsorbed on a carrier, wherein the polymer has a melting temperature, the heat labile component has a transformation temperature;
(b) subjecting the mixture to a processing temperature for a time sufficient to form a melt containing the polymer and the heat labile component adsorbed on the carrier; and
(c) cooling the melt to form at least one surface, wherein,
the processing temperature is ≧ the melting temperature of the polymer;
the processing temperature is > the heat labile component's transformation temperature; and
the heat labile component adsorbed on the carrier is distributed within the surface.

18. The method of claim 17, further including incorporating the surface into a member selected from the group consisting of structures, articles, containers, devices, woven/nonwoven articles, and remediation materials.

19. The method of claim 17, further including encapsulating the heat labile component adsorbed on a carrier within the polymer.

20. The method of claim 17, wherein providing a mixture including a polymer and a heat labile component adsorbed on a carrier involves providing a mixture including a heat labile biocide adsorbed on a carrier.

21. The method of claim 17, wherein providing a mixture including a polymer and a heat labile component adsorbed on a carrier involves providing a mixture including a quaternary amine derivative adsorbed on a carrier and the polymer's melting temperature is ≧180° C.

22. The method of claim 20, wherein providing a mixture including a polymer and a heat labile component adsorbed on a carrier involves providing a heat labile biocide selected from the group consisting of a bactericide, a fungicide, an algicide, a miticide, a viruscide, an insecticide, a herbicide, repellent, and combinations thereof.

23. The method of claim 17, wherein providing a mixture including a polymer and a heat labile component adsorbed on a carrier involves providing a polymer selected from the group consisting of a polyvinylchloride, a thermoplastic elastomer, a polyurethane, a high density polyethylene, a low density polyethylene, a silicone polymer, a fluorinated polyvinylchloride, a polystyrene, a styrene-acrylonitrile resin, a polyethylene terephthalate, a rayon, a styrene ethylene butadiene styrene rubber, a cellulose acetate butyrate, a polyoxymethylene acetyl polymer, a latex polymer, a natural rubber, a synthetic rubber, an epoxide polymer (including powder coats), and a polyamide.

24. A method for forming a solid polymer member having a surface and containing a heat labile component/carrier combination comprising:
(a) providing a heat labile component/carrier combination and a molten phase of the polymer at a liquid processing temperature;
(b) combining the heat labile component/carrier combination with the molten phase to provide a molten mixture, wherein the heat labile component has a transformation temperature and the transformation temperature is less than the liquid processing temperature and;
(c) subjecting the molten mixture to the processing temperature for a processing time sufficient to form a molten mixture containing the heat labile component/carrier combination; and
(d) cooling the molten mixture to form a solid member containing the heat labile component/carrier combination distributed throughout, including the member's surface.

25. The method of claim 24, wherein the transformation temperature is a decomposition temperature.

26. The method of claim 24, wherein the heat labile composition is a volatile component and the transformation temperature is a volatilization temperature.

27. A surface comprising a polymer having a continuous solid phase, and at least two incompatible components, wherein each incompatible component is adsorbed on a separate carrier, and wherein the incompatible components are components that when directly combined react with each other in a way that interferes with their combination.
